(19) United States
(12) Patent Application Publication
(10) Pub. No.: US 2024/0092598 A1
(43) Pub. Date: Mar. 21, 2024

(54) SUCTION ROLLER, INK-JET PRINTER AND SUCTION WIDTH ADJUSTMENT METHOD BY SUCTION ROLLER

(71) Applicant: SCREEN HOLDINGS CO., LTD., Kyoto (JP)

(72) Inventors: Hitoshi MATSUYA, Kyoto (JP); Shinsuke YAMASHITA, Kyoto (JP); Takaharu YAMAMOTO, Kyoto (JP)

(21) Appl. No.: 18/456,007

(22) Filed: Aug. 25, 2023

(30) Foreign Application Priority Data
Sep. 21, 2022 (JP) 2022-149901

(51) Int. Cl. B65H 20/12

(52) U.S. Cl. CPC B65H 20/12; B65H 2801/06

(57) ABSTRACT

The overlapping regions L are formed by overlapping the outer cylinder vent holes and the inner cylinder vent holes. If the suction port of the inner cylinder receives a suction force from the blower, air is sucked toward the suction port from the suction chamber facing the overlapping region L of the inner cylinder vent hole and the outer cylinder vent hole, out of the plurality of suction chambers, via the overlapping region L. The outer cylinder and the inner cylinder are so configured that the overlapping region L becomes narrower in the rotation direction Dr from the center toward the both ends in the axial direction Da.

### CROSS REFERENCE TO RELATED APPLICATION

The disclosure of Japanese Patent Application No. 2022-149901 filed on Sep. 21, 2022 including specification, drawings and claims is incorporated herein by reference in its entirety.

This invention relates to a technique for sucking a base material by a suction roller.

### BACKGROUND OF THE INVENTION

### 1. Field of the Invention

In an ink-jet printer for printing an image on a base material by discharging an ink to the base material, rollers are used to convey the base material. Further, to stably convey the base material, a suction roller described, for example, in JP 2003-072997A, can be used. This suction roller includes a roller formed with a multitude of openings, and the base material (web) in contact with the roller is sucked by the openings.

### 2. Description of the Related Art

Specifically, the suction roller is provided with a fixed cylinder inserted in the roller and a plurality of suction chambers arranged in a width direction of the base material between the inner peripheral surface of the roller and the outer peripheral surface of the fixed cylinder. A plurality of holes are arranged in the width direction of the base material in the peripheral surface of the fixed cylinder, and each hole of the fixed cylinder can communicate with the corresponding one of the plurality of suction chambers. Further, a shaft member is inserted inside the fixed cylinder and rotatable with respect to the fixed cylinder. A plurality of holes are arranged in the width direction of the base material in the peripheral surface of this shaft member. If the inside of the shaft member is sucked in a state where an overlapping region of the hole of the fixed cylinder and the hole of the shaft member is formed, the corresponding suction chamber is sucked via this overlapping region and the base material is sucked by the opening of the roller communicating with this suction chamber. Further, in the shaft member, a plurality of holes are arranged in the width direction at each of two rotational positions different by 180° in a rotation direction. A width over which these holes are provided differs between the two rotational positions. Therefore, by rotating the shaft member, a width over which the overlapping regions of the holes of the fixed cylinder and the holes of the shaft member are formed, can be changed. In this way, a suction width of the suction roller to suck the base material can be changed.

### SUMMARY OF THE INVENTION

The above suction roller had at least the following problem. That is, there has been a problem that the base material sucked by the suction roller is creased due to an improper distribution of a suction pressure in the width direction of the base material, i.e. in an axial direction of the suction roller. Further, there has been also a problem that an operation of changing the suction width of the suction roller according to the width of the base material becomes a burden on an operator.

This invention was developed in view of the above problems and aims to solve at least one of a problem of creasing a base material sucked by a suction roller and a problem of reducing a burden required for an operation of changing a suction width of the suction roller.

According to a first aspect of the invention, a suction roller conveying a base material while sucking and supporting the base material, comprises: a cylindrical roller having an outer peripheral surface formed with a plurality of openings to suck and support the base material, the cylindrical roller configured to rotate about a cylindrical axis, an outer cylinder having an outer peripheral surface formed with an outer cylinder vent hole through which air passes, the outer cylinder being inserted into the cylindrical roller; an inner cylinder having a suction port receiving a suction force from a suction source and an outer peripheral surface formed with an inner cylinder vent hole through which air passes, the inner cylinder being inserted in the outer cylinder; and a plurality of suction chambers formed to be arranged in a longitudinal direction between an inner peripheral surface of the cylindrical roller and the outer peripheral surface of the outer cylinder, the cylindrical roller being configured such that each of the plurality of openings communicates with the corresponding one of the plurality of suction chambers, an overlapping region being formed by overlapping the outer cylinder vent hole and the inner cylinder vent hole, the outer cylinder and the inner cylinder being configured such that air is sucked toward the suction port via the overlapping region from the suction chamber facing the overlapping region of the inner cylinder vent hole and the outer cylinder vent hole, out of the plurality of suction chambers, when the suction port of the inner cylinder receives a suction force from the suction source, and the outer cylinder and the inner cylinder being configured such that the overlapping region becomes narrower from a center toward both ends in the longitudinal direction.

The suction roller thus configured is provided with the cylindrical roller, the outer cylinder inserted in the cylindrical roller and the plurality of suction chambers formed to be arranged in the longitudinal direction between the inner peripheral surface of the cylindrical roller and the outer peripheral surface of the outer cylinder. The plurality of openings for sucking and supporting the base material are formed in the outer peripheral surface of the cylindrical roller, and the cylindrical roller is configured such that each of the plurality of openings communicates with the corresponding one of the plurality of suction chambers. Further, the outer cylinder vent hole, through which air can pass, is formed in the outer peripheral surface of the outer cylinder. Further, the inner cylinder is provided which has the outer peripheral surface formed with the inner cylinder vent hole, through which air can pass, and is inserted in the outer cylinder. The overlapping region is formed by overlapping the outer cylinder vent hole and the inner cylinder vent hole. If the suction port of the inner cylinder receives a suction force from the suction source, air is sucked toward the suction port from the suction chamber facing the overlapping region of the inner cylinder vent hole and the outer cylinder vent hole, out of the plurality of suction chambers, via the overlapping region. Moreover, the outer cylinder and the inner cylinder are so configured that the overlapping region becomes narrower from the center toward the both ends in the longitudinal direction. Thus, a pressure of the cylindrical roller to suck the base material is reduced from the center toward the ends of the cylindrical roller. In other words, the cylindrical roller sucks the base material with a strong pressure in a central part of the cylindrical roller, and sucks the base material with a pressure lower than that in the central part of the cylindrical roller in both end parts of the cylindrical roller. Therefore, even if the base material in contact with the central part of the cylindrical roller is creased, the crease of the base material is corrected along the outer peripheral surface of the cylindrical roller since the base material is sucked with a strong pressure in the central part of the cylindrical roller. Further, since the base material is sucked with a weak pressure in the both end parts of the cylindrical roller, both end parts of the base material can be shifted in the longitudinal direction according to the crease correction of the base material in the central part. In this way, the crease of the base material is stretched in the longitudinal direction. As a result, a problem of creasing the base material sucked by the suction roller can be solved.

According to a second aspect of the invention, a suction roller conveying a base material while sucking and supporting the base material, comprises: a cylindrical roller having an outer peripheral surface formed with a plurality of openings to suck and support the base material, the cylindrical roller configured to rotate about a cylindrical axis, an outer cylinder having an outer peripheral surface formed with an outer cylinder vent hole, through which air passes, the outer cylinder being inserted into the cylindrical roller; an inner cylinder having a suction port receiving a suction force from a suction source and an outer peripheral surface formed with an inner cylinder vent hole, through which air passes, the inner cylinder being inserted into the outer cylinder and configured to be relatively movable in a predetermined moving direction with respect to the outer cylinder; and a plurality of suction chambers formed to be arranged in a longitudinal direction between an inner peripheral surface of the cylindrical roller and the outer peripheral surface of the outer cylinder, the cylindrical roller being configured such that each of the plurality of openings communicates with the corresponding one of the plurality of suction chambers, an overlapping region being formed by overlapping the outer cylinder vent hole and the inner cylinder vent hole, the outer cylinder and the inner cylinder being configured such that air is sucked toward the suction port via the overlapping region from the suction chamber facing the overlapping region of the inner cylinder vent hole and the outer cylinder vent hole, out of the plurality of suction chambers, when the suction port of the inner cylinder receives a suction force from the suction source, a length of the overlapping region in the moving direction changing according to position in the longitudinal direction, and the outer cylinder and the inner cylinder being configured such that the length of the overlapping region in the moving direction being adjustable by relatively moving the inner cylinder in the moving direction with respect to the outer cylinder to change a positional relationship between the outer cylinder vent hole and the inner cylinder vent hole.

The suction roller thus configured is provided with the cylindrical roller, the outer cylinder inserted in the cylindrical roller and the plurality of suction chambers formed to be arranged in the longitudinal direction between the inner peripheral surface of the cylindrical roller and the outer peripheral surface of the outer cylinder. The plurality of openings for sucking and supporting the base material are formed in the outer peripheral surface of the cylindrical roller, and the cylindrical roller is configured such that each of the plurality of openings communicates with the corresponding one of the plurality of suction chambers. Further, the outer cylinder vent hole, through which air can pass, is formed in the outer peripheral surface of the outer cylinder. Furthermore, the inner cylinder is provided which has the outer peripheral surface formed with the inner cylinder vent hole, through which air can pass, and is inserted in the outer cylinder. The overlapping region is formed by overlapping the outer cylinder vent hole and the inner cylinder vent hole. If the suction port of the inner cylinder receives a suction force from the suction source, air is sucked toward the suction port from the suction chamber facing the overlapping region of the inner cylinder vent hole and the outer cylinder vent hole, out of the plurality of suction chambers, via the overlapping region. Moreover, the length of the overlapping region in the moving direction changes according to position in the longitudinal direction parallel to the cylindrical axis and, further, is adjustable by relatively moving the inner cylinder in the moving direction with respect to the outer cylinder to change the positional relationship between the outer cylinder vent hole and the inner cylinder vent hole. Therefore, a pressure for sucking the base material can be changed in the longitudinal direction according to a characteristic of the base material. As a result, the problem of creasing the base material sucked by the suction roller can be solved.

According to a third aspect of the invention, an ink-jet printer printing an image on a base material by supplying an ink while conveying the base material, comprises: a conveyor including a suction roller to suck and support the base material, the conveyor conveying the base material; a printing part configured to print an image on the base material being conveyed by the conveyor by discharging an ink from an ink-jet nozzle; an input part to which data representing a width of the base material is input; a suction part configured to suck the suction roller; a switching part configured to switch a suction width of the base material by the suction roller; and a controller, the controller including a switching controller configured to control the switching part to switch the suction width of the suction roller according to the width of the base material input to the input part.

According to the third aspect of the invention, a suction width adjustment method by a suction roller in an ink-jet printer printing an image on a base material by supplying an ink while conveying the base material by a conveyor including the suction roller to suck and support the base material, comprises: inputting data representing a width of the base material to an input part; and controlling a switching part switching the suction width such that the suction width of the suction roller to suck the base material is switched according to the width of the base material input to the input part.

In the ink-jet printer thus configured, if the data representing the width of the base material is input to the input part, the switching part is controlled to switch the suction width of the suction roller according to this width of the base material. Therefore, an operator can change the suction width of the suction roller only by performing an operation of inputting the data representing the width of the base material. As a result, a problem of reducing a burden required for an operation of changing the suction width of the suction roller can be solved.

As described above, the crease of the base material sucked by the suction roller can be suppressed according to the first and second aspects of the invention, and a burden required for an operation of changing the suction width of the suction roller can be reduced according to the third aspect of the invention. The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a front view schematically showing an example of a printing system provided with an ink-jet printer according to the invention.

FIG. 2 is a front view schematically showing the ink-jet printer equipped in the printing system of FIG. 1.

FIG. 3A shows a state where the first inner cylinder vent hole formation range Ri1 is facing the outer cylinder vent hole formation range Ro.

FIG. 3B shows a state where the second inner cylinder vent hole formation range Ri2 is facing the outer cylinder vent hole formation range Ro.

FIG. 3C shows a state where the third inner cylinder vent hole formation range Ri3 is facing the outer cylinder vent hole formation range Ro.

FIG. 4 is a partial sectional view schematically showing the outer cylinder and the inner cylinder in a cross-section perpendicular to the axial direction of the suction roller.

FIG. 5A is a chart schematically showing the size of each overlapping region formed by the inner cylinder vent hole provided in the first inner cylinder vent hole formation range and the outer cylinder vent hole.

FIG. 5B is a chart schematically showing the size of each overlapping region formed by the inner cylinder vent hole provided in the second inner cylinder vent hole formation range and the outer cylinder vent hole.

FIG. 5C is a chart schematically showing the size of each overlapping region formed by the inner cylinder vent hole provided in the third inner cylinder vent hole formation range and the outer cylinder vent hole.

FIG. 6 is a diagram schematically showing an example of the inner cylinder rotation mechanism.

FIG. 7 is a diagram schematically showing the suction mechanism configured to suck the suction port of the suction roller.

FIG. 8A is a block diagram showing an electrical configuration of a controller configured to control the operations of the inner cylinder rotation mechanism and the suction mechanism.

FIG. 8B shows an example of the rotational position table.

FIG. 9A is a block diagram showing an electrical configuration of a controller according to a modification.

FIG. 9B shows an example of the suction pressure table.

FIG. 10A is a chart schematically showing the size of each overlapping region formed by the outer cylinder vent hole and the inner cylinder vent hole provided in the first inner cylinder vent hole formation range in the modification.

FIG. 10B is a chart schematically showing the size of each overlapping region formed by the outer cylinder vent hole and the inner cylinder vent hole provided in the second inner cylinder vent hole formation range in the modification.

FIG. 10C is a chart schematically showing the size of each overlapping region formed by the outer cylinder vent hole and the inner cylinder vent hole provided in the third inner cylinder vent hole formation range in the modification.

FIG. 11 is a flow chart showing an example of a control executed by the controller.

FIG. 12 is a block diagram showing an electrical configuration of the controller for carrying out the flow chart of FIG. 11.

FIG. 13A is a chart schematically showing a first modification of the outer cylinder vent holes and the inner cylinder vent holes.

FIG. 13B is a chart schematically showing a first modification of the outer cylinder vent holes and the inner cylinder vent holes.

FIG. 14A is a chart schematically showing a second modification of the outer cylinder vent holes and the inner cylinder vent holes.

FIG. 14B is a chart schematically showing a second modification of the outer cylinder vent holes and the inner cylinder vent holes.

FIG. 15 is a chart showing a modification of a mode of change of the lengths in the rotation direction of the overlapping regions in the axial direction by a graph.

FIG. 16A is a perspective view showing the attachment component of the suction roller.

FIG. 16B is a perspective view showing the attachment component of the suction roller.

FIG. 16C is a partial sectional view showing the attachment component of the suction roller.

FIG. 17A is a diagram schematically showing a modification of a configuration relating to the suction chambers.

FIG. 17B is a diagram schematically showing a modification of a configuration relating to the suction chambers.

FIG. 17C is a diagram schematically showing a modification of a configuration relating to the suction chambers.

### DETAILED DESCRIPTION OF THE PREFERRED EMBODIMENTS

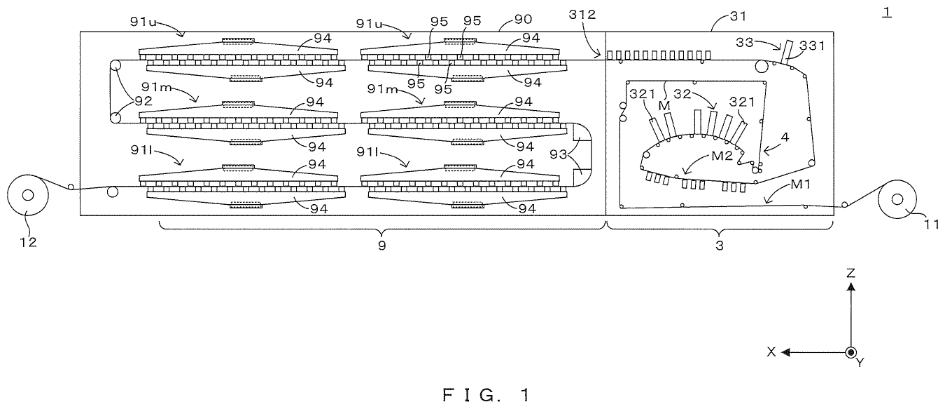

FIG. 1 is a front view schematically showing an example of a printing system provided with an ink-jet printer according to the invention. In FIG. 1 and subsequent figures, an X direction, which is a horizontal direction, a Y direction, which is a horizontal direction orthogonal to the X direction, and a Z direction, which is a vertical direction, are shown as appropriate. As shown in FIG. 1, the printing system 1 includes an ink-jet printer 3 and a dryer 9 arrayed in the X direction. This printing system 1 conveys a printing medium M in the form of a web in a roll-to-roll manner from a feed roll 11 to a take-up roll 12. Note that a material of the printing medium M is a film of OPP (oriented polypropylene), PET (polyethylene terephthalate) or the like. However, the material of the printing medium M is not limited to the film and may be paper or the like. Such a printing medium M is flexible. Further, out of both surfaces of the printing medium M, a surface on which an image is printed is referred to as a front surface M1 and a surface opposite to the front surface M1 is referred to as a back surface M2 as appropriate.

The ink-jet printer 3 prints an image on the front surface M1 of the printing medium M by discharging water-based inks to the front surface M1 of the printing medium M being conveyed from the feed roll 11 to the take-up roll 12 in an ink-jet method. A detailed configuration of such an ink-jet printer 3 is described later. The printing medium M having the image printed in this way is conveyed in the X direction from the ink-jet printer 3 to the dryer 9.

The dryer 9 includes a drying furnace 90 and dries the printing medium M carried out from the ink-jet printer 3 as the printing medium M is conveyed from the feed roll 11 to the take-up roll 12. Two upper-stage blower units 91u arrayed in the X direction, two middle-stage blower units 91m arrayed in the X direction below these upper-stage blower units 91u and two lower-stage blower units 911 arrayed in the X direction below these middle-stage blower units 91m are provided in the drying furnace 90.

The printing medium M carried out through a carry-out port 312 of the ink-jet printer 3 is folded toward the two middle-stage blower units 91m by one pair of rollers 92 after passing in the X direction through the two upper-stage blower units 91u. Subsequently, the printing medium M is folded toward the two lower-stage blower units 911 by one pair of air turn bars 93 after passing in the X direction through the two middle-stage blower units 91m. Further, the printing medium M is carried out to the outside of the dryer 9 after passing in the X direction through the two lower-stage blower units 911.

The upper-stage blower unit 91u includes two blower chambers 94 arranged to sandwich the printing medium M passing in the X direction in the Z direction. Each blower chamber 94 includes a plurality of nozzles 95 arrayed in the X direction and injects hot air (gas of 60° C. or higher) from each nozzle 95 to the printing medium M. In this way, the printing medium M is dried by the hot air injected from the nozzles 95 of these blower chambers 94 while passing between the two blower chambers 94 provided on upper and lower sides. Further, each of the middle-stage blower units 91m and the lower-stage blower units 911 also includes two blower chambers 94 for sandwiching the printing medium M in the Z direction, similarly to the upper-stage blower units 91u.

By the way, a specific configuration of the upper-stage blower unit 91u is not limited to the one in this example. For example, a plurality of rollers arrayed in the X direction may be provided instead of the lower blower chamber 94, out of the upper and lower blower chambers 94 of the upper-stage blower unit 91u. In such a configuration, the hot air can be injected to the front surface M1 of the printing medium M from the upper blower chamber 94 while the back surface M2 of the printing medium M is supported from below by the plurality of rollers.

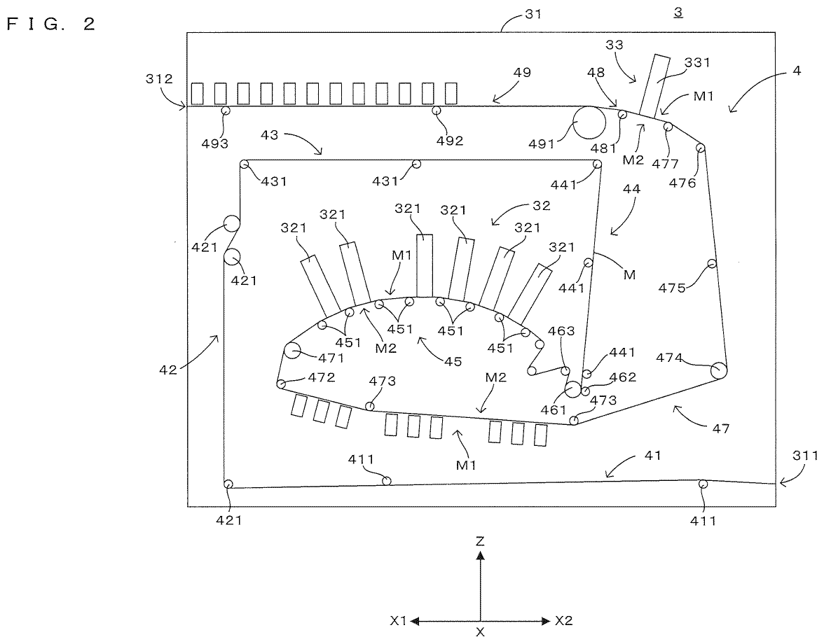

FIG. 2 is a front view schematically showing the ink-jet printer equipped in the printing system of FIG. 1. In FIG. 2, one side X1 and another side X2 in the X direction are shown as appropriate. Here, the one side X1 is a side from the ink-jet printer 3 toward the dryer 9, and the other side X2 is a side opposite to the one side X1. The ink-jet printer 3 includes a housing 31, a color printing part 32 arranged in the housing 31, a white printing part 33 arranged above the color printing part 32 in the housing 31, and a conveyor 4 configured to convey the printing medium M by a plurality of rollers arranged in the housing 31.

The color printing part 32 includes a plurality of (six) head units 321 arrayed in a moving direction (direction from the other side X2 toward the one side X1) of the printing medium M above the printing medium M being conveyed by the conveyor 4. The plurality of head units 321 include nozzles facing the front surface M1 of the printing medium M passing therebelow from above, and discharge color inks having mutually different colors in the ink-jet method. Here, the color inks mean inks other than that having a white color and include inks of cyan, magenta, yellow, black and the like. In this way, the plurality of head units 321 of the color printing part 32 print a color image on the front surface M1 of the printing medium M by discharging the color inks to the front surface M1 of the printing medium M passing therebelow from above.

Further, the white printing part 33 includes a single head unit 331 arranged above the printing medium M being conveyed by the conveyor 4. The head unit 331 includes nozzles facing the front surface M1 of the printing medium M passing therebelow from above, and discharges a white ink from the nozzles in the ink-jet method. In this way, the head unit 331 of the white printing part 33 prints a white image on the front surface M1 of the printing medium M by discharging the white ink to the front surface M1 of the printing medium M passing therebelow from above.

A carry-in port 311 is open in a side wall on the other side X2 of the housing 31, whereas a carry-out port 312 is open in a side wall on the one side X1 of the housing 31. The printing medium M is conveyer by the conveyor 4 from the carry-in port 311 to the carry-out port 312 by way of the color printing part 32 and the white printing part 33 described above.

This conveyor 4 includes a carry-in part 41 provided below the color printing part 32, an ascending conveyor 42 provided on the one side X1 of the color printing part 32, an upper conveyor 43 provided above the color printing part 32 and a descending conveyor 44 provided on the other side X2 of the color printing part 32. The carry-in part 41 conveys the printing medium M carried in through the carry-in port 311 toward the one side X1 by rollers 411, the ascending conveyor 42 conveys the printing medium M conveyed by the carry-in part 41 upward by rollers 421, the upper conveyor 43 conveys the printing medium M conveyed by the ascending conveyor 42 toward the other side X2 by rollers 431, and the descending conveyor 44 conveys the printing medium M conveyed by the upper conveyor 43 downward by rollers 441.

Further, the conveyor 4 includes a color conveyor 45 for supporting the printing medium M facing the color printing part 32 from below, and the printing medium M passed through the descending conveyor 44 enters the color conveyor 45. This color conveyor 45 includes a plurality of rollers 451 arrayed from the other side X2 to the one side X1 and each roller 451 contacts the back surface M2 of the printing medium M from below. In this way, the front surface M1 of the printing medium M supported by the color conveyor 45 is facing up and each head unit 321 of the color printing part 32 discharges the color ink to this front surface M1 while facing this front surface M1 from above.

Further, the conveyor 4 includes rollers 461, 462 and 463 arranged between the color conveyor 45 and the descending conveyor 44 in the moving direction of the printing medium M. The roller 461 is a drive roller for driving the printing medium M. The rollers 462, 463 are driven rollers which rotate, following the printing medium M. In a conveying direction of the printing medium M, the roller 462 contacts the printing medium M on a side upstream of the drive roller 461, and the roller 463 contacts the printing medium M on a side downstream of the drive roller 461.

Furthermore, the conveyor 4 includes an inverting conveyor 47 for vertically inverting the printing medium M conveyed to the one side X1 from the color conveyor 45 twice. This inverting conveyor 47 includes a plurality of the rollers 471 to 477 including the drive roller 471, and these rollers 471 to 477 vertically invert the printing medium M twice while contacting the back surface M2 of the printing medium M. That is, the inverting conveyor 47 vertically inverts the front surface M1 and the back surface M2 of the printing medium M by conveying the printing medium M conveyed from the color conveyor 45 downward by the rollers 471, 472 and further conveying the printing medium M with the moving direction of the printing medium M changed to the one toward the other side X2 by the roller 472. Subsequently, the inverting conveyor 47 conveys the printing medium M from the one side X1 to the other side X2 by a plurality of the rollers 473 and then conveys the printing medium M upward by the rollers 474, 475 and 476. Further, the inverting conveyor 47 vertically inverts the front surface M1 and the back surface M2 of the printing medium M again by changing the moving direction of the printing medium M to the one toward the one side X1 by the roller 476 and conveys the printing medium M from the other side X2 to the one side X1 by the roller 477.

Further, the conveyor 4 includes a white conveyor 48 for supporting the printing medium M facing the white printing part 33 from below, and the printing medium M vertically inverted twice by the inverting conveyor 47 enters the white conveyor 48. This white conveyor 48 includes a roller 481 configured to contact the back surface M2 of the printing medium M from below. In this way, the front surface M1 of the printing medium M supported by the white conveyor 48 is facing up, and the head unit 331 of the white printing part 33 discharges the white ink to this front surface M1 while facing this front surface M1 from above.

Furthermore, the conveyor 4 includes a carry-out part 49 provided above the upper conveyor 43. The carry-out part 49 includes a plurality of rollers 491, 492 and 493 arrayed from the other side X2 to the one side X1 in the X direction. This carry-out part 49 conveys the printing medium M conveyed by the white conveyor 48 to the dryer 6 through the carry-out port 312 of the housing 31 by conveying the printing medium M to the one side X1 by the plurality of rollers 491, 492 and 493.

As described above, a color image is printed on the printing medium M being conveyed in the conveying direction by the conveyor 4 by the color printing part 32 discharging the inks. Further, the conveyor 4 includes the rollers 463 and 471 provided on both sides in the conveying direction of the printing medium M, to which the inks are discharged from the color printing part 32. The roller 463 is arranged upstream of the color printing part 32 in the conveying direction of the printing medium M and supports the printing medium M before the inks are discharged from the color printing part 32. The roller 471 is arranged downstream of the color printing part 32 in the conveying direction of the printing medium M and supports the printing medium M after the inks are discharged from the color printing part 32. On the other hand, the roller 463 is a concave roller having an outer peripheral surface shaped to increase a diameter from a center toward ends in an axial direction of the roller 463, and supports the printing medium M by this outer peripheral surface. Further, the roller 471 is a suction roller having an outer peripheral surface for sucking air, and supports the printing medium M by rotating while sucking the printing medium M by this outer peripheral surface.

Further, a white image is printed on the printing medium M being conveyed in the conveying direction by the conveyor 4 by the white printing part 33 discharging the ink. Further, the conveyor 4 includes the rollers 475, 491 provided on both sides in the conveying direction of the printing medium M, to which the ink is discharged from the white printing part 33. The roller 475 is arranged upstream of the white printing part 33 in the conveying direction of the printing medium M and supports the printing medium M before the ink is discharged from the white printing part 33. The roller 491 is arranged downstream of the white printing part 33 in the conveying direction of the printing medium M and supports the printing medium M after the ink is discharged from the white printing part 33. On the other hand, the roller 475 is a concave roller having an outer peripheral surface shaped to increase a diameter from a center toward ends in an axial direction of the roller 475, and supports the printing medium M by this outer peripheral surface. Further, the roller 491 is a suction roller having an outer peripheral surface for sucking air, and supports the printing medium M by rotating while sucking the printing medium M by this outer peripheral surface.

That is, the concave roller and the suction roller are provided which support the printing medium M, to which the ink(s) is/are discharged from the printing part such as the color printing part 32 or white printing part 33, on both sides in the conveying direction of the printing medium M. The concave roller is arranged upstream of the printing part in the conveying direction of the printing medium M, and supports the printing medium M before the ink(s) is/are discharged from the printing part. The suction roller is arranged downstream of the printing part in the conveying direction of the printing medium, and supports the printing medium M after the ink(s) is/are discharged from the printing part. Next, such a suction roller is described in detail.

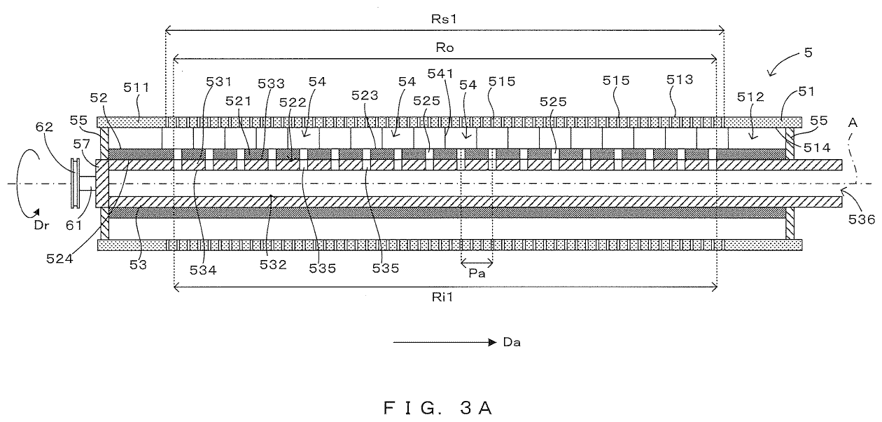

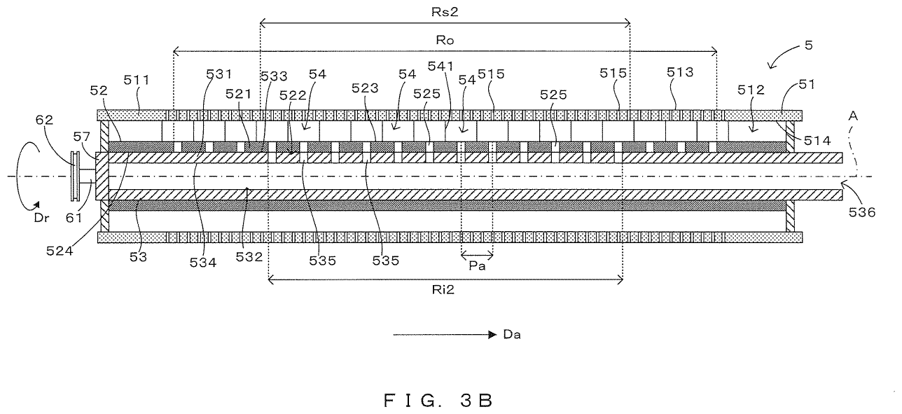

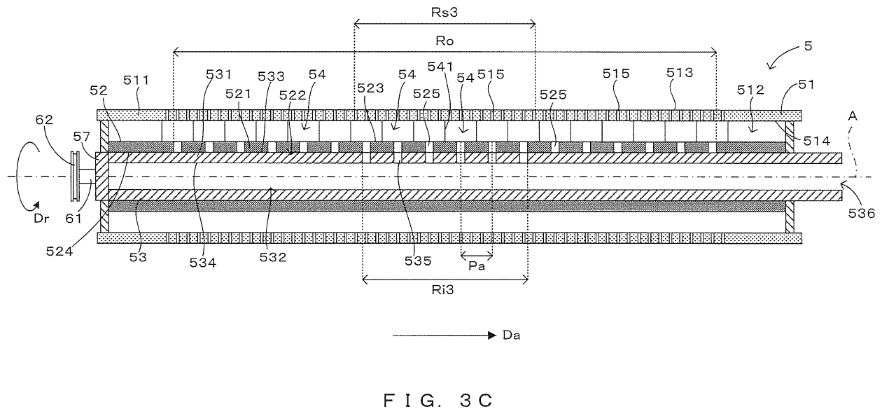

FIGS. 3A, 3C and 3C are partial sectional views schematically showing a cross-section parallel to an axial direction of the suction roller. In FIG. 3 and subsequent figures, an axial direction Da of the suction roller 5 and a rotation direction Dr centered on an axis of rotation A parallel to the axial direction Da are shown as appropriate. As shown in these figures, the suction roller 5 comprises a cylindrical roller 51, an outer cylinder 52, an inner cylinder 53 and suction chambers 54.

That is, the suction roller 5 includes the cylindrical roller 51 supporting the printing medium M by contacting the printing medium M. The cylindrical roller 51 includes a cylindrical roller body 511 and a hollow part 512 formed inside the cylindrical roller body 511. An outer peripheral surface 513 of the cylindrical roller body 511 has a cylindrical shape centered on the axial direction Da, and contacts the printing medium M. An inner peripheral surface 514 of the cylindrical roller body 511 has a cylindrical shape centered on the axial direction Da and defines the hollow part 512. Further, the cylindrical roller body 511 is formed with a plurality of openings 515. The opening 515 is provided between the outer peripheral surface 513 and the inner peripheral surface 514, one end of the opening 515 is open in the outer peripheral surface 513, and the other end of the opening 515 is open in the inner peripheral surface 514. Therefore, air can pass through the openings 515 from the side of the outer peripheral surface 513 to the side of the inner peripheral surface 514. Such openings 515 may be holes penetrating through the cylindrical roller body 511 or meshes formed in the cylindrical roller body 511. The plurality of openings 515 are formed over a first suction range Rs1 having a predetermined width in the axial direction Da.

Further, the suction roller 5 comprises the outer cylinder 52 arranged inside the cylindrical roller 51 (i.e. in the hollow part 512 of the cylindrical roller 51). The outer cylinder 52 includes an outer cylinder body 521 and a hollow part 522 formed inside the outer cylinder body 521. An outer peripheral surface 523 of the outer cylinder body 521 has a cylindrical shape centered on the axial direction Da, and faces the inner peripheral surface 514 of the cylindrical roller 51 across a gap. An inner peripheral surface 524 of the outer cylinder body 521 has a cylindrical shape centered on the axial direction Da and defines the hollow part 522. Further, in the outer cylinder body 521, a plurality of outer cylinder vent holes 525 are formed to be arranged at arrangement intervals Pa in the axial direction Da. The outer cylinder vent hole 525 is provided between the outer peripheral surface 523 and the inner peripheral surface 524, one end of the outer cylinder vent hole 525 is open in the outer peripheral surface 523, and the other end of the outer cylinder vent hole 525 is open in the inner peripheral surface 524. Therefore, air can pass through the outer cylinder vent holes 525 from the side of the outer peripheral surface 523 to the side of the inner peripheral surface 524. Such outer cylinder vent holes 525 may be holes penetrating through the outer cylinder body 521 or meshes formed in the outer cylinder body 521. The plurality of outer cylinder vent holes 525 are formed over an outer cylinder vent hole formation range Ro having a predetermined width in the axial direction Da.

Further, the suction roller 5 comprises a plurality of the suction chambers 54 provided between the inner peripheral surface 514 of the cylindrical roller 51 and the outer peripheral surface 523 of the outer cylinder 52. The plurality of suction chambers 54 are formed to be arranged in the axial direction Da. In the axial direction Da, the suction chambers 54 adjacent to each other are isolated by separation walls 541. Further, each suction chamber 54 is open both on the side of the cylindrical roller 51 and on the side of the outer cylinder 52. The cylindrical roller 51 is configured such that each of the plurality of openings 515 of the cylindrical roller 51 faces one suction chamber 54, out of the plurality of suction chambers 54, and communicates with this one suction chamber 54. Further, the outer cylinder 52 is configured such that each of the plurality of outer cylinder vent holes 525 of the outer cylinder 52 faces one of the plurality of suction chambers 54 and communicates with this one suction chamber 54. Therefore, the opening 515 of the cylindrical roller 51, the suction chamber 54 facing this opening 515 and the outer cylinder vent hole 525 facing this suction chamber 54 communicate with each other.

Furthermore, the suction roller 5 comprises the inner cylinder 53 arranged inside the outer cylinder 52 (i.e. in the hollow part 522 of the outer cylinder 52). The inner cylinder 53 includes an inner cylinder body 531 and a hollow part 532 formed inside the inner cylinder body 531. An outer peripheral surface 533 of the inner cylinder body 531 has a cylindrical shape centered on the axial direction Da, and faces the inner peripheral surface 524 of the outer cylinder 52 across a tiny gap. An inner peripheral surface 534 of the inner cylinder body 531 has a cylindrical shape centered on the axial direction Da and defines the hollow part 532. Further, in the inner cylinder body 531, a plurality of inner cylinder vent holes 535 are formed to be arranged at arrangement intervals Pa in the axial direction Da. The inner cylinder vent hole 535 is provided between the outer peripheral surface 533 and the inner peripheral surface 534, one end of the inner cylinder vent hole 535 is open in the outer peripheral surface 533, and the other end of the inner cylinder vent hole 535 is open in the inner peripheral surface 534. Therefore, air can pass through the inner cylinder vent holes 535 from the side of the outer peripheral surface 533 to the side of the inner peripheral surface 534. Such inner cylinder vent holes 535 may be holes penetrating through the inner cylinder body 531 or meshes formed in the inner cylinder body 531.

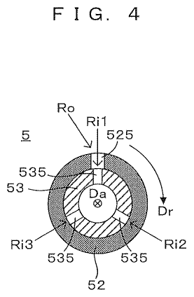

Further, a plurality of (three) inner cylinder vent hole formation range Ri1, Ri2 and Ri3 provided at positions different from each other in the rotation direction Dr are provided in the inner cylinder 53, and the inner cylinder vent holes 535 are formed to be arranged at the arrangement intervals Pa in the axial direction Da in each of the plurality of inner cylinder vent hole formation range Ri1, Ri2 and Ri3 (FIG. 4).

FIG. 4 is a partial sectional view schematically showing the outer cylinder and the inner cylinder in a cross-section perpendicular to the axial direction of the suction roller. As shown in FIG. 4, the first inner cylinder vent hole formation range Ri1, the second inner cylinder vent hole formation range Ri2 and the third inner cylinder vent hole formation range Ri3 are arranged at angular intervals of 120° in the rotation direction Dr in the inner cylinder 53. Further, the inner cylinder 53 is rotatable in the rotation direction Dr with respect to the outer cylinder 52, and one of the first, second and third inner cylinder vent hole formation range Ri1, Ri2 and Ri3 selectively faces the outer cylinder vent hole formation range Ro.

FIG. 3A shows a state where the first inner cylinder vent hole formation range Ri1 is facing the outer cylinder vent hole formation range Ro. The first inner cylinder vent hole formation range Ri1 coincides with the outer cylinder vent hole formation range Ro in the axial direction Da, and the inner cylinder vent holes 535 are formed over the first inner cylinder vent hole formation range Ri1 in the axial direction Da. Each of the outer cylinder vent holes 525 of the outer cylinder 52 faces any one of the respective inner cylinder vent holes 535 in the first inner cylinder vent hole formation range Ri1 and communicates with this inner cylinder vent hole 535. Therefore, air can flow into the hollow part 532 of the inner cylinder 53 from the outer cylinder vent hole 525 via the inner cylinder vent hole 535 communicating with the outer cylinder vent hole 525.

FIG. 3B shows a state where the second inner cylinder vent hole formation range Ri2 is facing the outer cylinder vent hole formation range Ro. In the axial direction Da, a width of the second inner cylinder vent hole formation range Ri2 is narrower than that of the first inner cylinder vent hole formation range Ri1. Further, a center of the second inner cylinder vent hole formation range Ri2 coincides with that of the first inner cylinder vent hole formation range Ri1 in the axial direction Da. Out of the respective outer cylinder vent holes 525 of the outer cylinder 52, the outer cylinder vent hole 525 overlapping the second inner cylinder vent hole formation range Ri2 faces any one of the respective inner cylinder vent holes 535 in the second inner cylinder vent hole formation range Ri2 and communicates with this inner cylinder vent hole 535. Therefore, in the second inner cylinder vent hole formation range Ri2, air can flow into the hollow part 532 of the inner cylinder 53 from the outer cylinder vent hole 525 via the inner cylinder vent hole 535 communicating with the outer cylinder vent hole 525. On the other hand, out of the respective outer cylinder vent holes 525 of the outer cylinder 52, the outer cylinder vent holes 525 not overlapping the second inner cylinder vent hole formation range Ri2 are closed by the outer peripheral surface 533 of the inner cylinder 53. Therefore, the inflow of air into the hollow part 532 of the inner cylinder 53 from the outer cylinder vent holes 525 is restricted outside the second inner cylinder vent hole formation range Ri2.

FIG. 3C shows a state where the third inner cylinder vent hole formation range Ri3 is facing the outer cylinder vent hole formation range Ro. In the axial direction Da, a width of the third inner cylinder vent hole formation range Ri3 is narrower than that of the second inner cylinder vent hole formation range Ri2. Further, a center of the third inner cylinder vent hole formation range Ri3 coincides with that of the second inner cylinder vent hole formation range Ri2 in the axial direction Da. Out of the respective outer cylinder vent holes 525 of the outer cylinder 52, the outer cylinder vent hole 525 overlapping the third inner cylinder vent hole formation range Ri3 faces any one of the respective inner cylinder vent holes 535 in the third inner cylinder vent hole formation range Ri3 and communicates with this inner cylinder vent hole 535. Therefore, in the third inner cylinder vent hole formation range Ri3, air can flow into the hollow part 532 of the inner cylinder 53 from the outer cylinder vent hole 525 via the inner cylinder vent hole 535 communicating with the outer cylinder vent hole 525. On the other hand, out of the respective outer cylinder vent holes 525 of the outer cylinder 52, the outer cylinder vent holes 525 not overlapping the third inner cylinder vent hole formation range Ri3 are closed by the outer peripheral surface 533 of the inner cylinder 53. Therefore, the inflow of air into the hollow part 532 of the inner cylinder 53 from the outer cylinder vent holes 525 is restricted outside the third inner cylinder vent hole formation range Ri3.

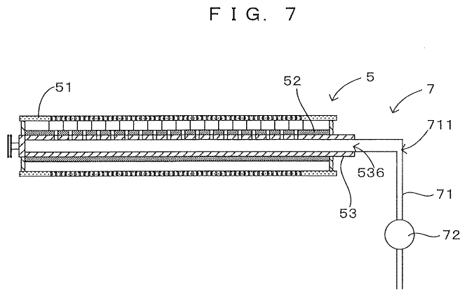

On one end of the inner cylinder 53 in the axial direction Da, the hollow part 532 is open to form a suction port 536. If the suction port 536 is sucked by a blower 72 (FIG. 7) to be described later, a negative pressure is generated in the hollow part 532 of the inner cylinder 53. This negative pressure is transmitted to the opening 515 facing the suction chamber 54 via the inner cylinder vent hole 535, the outer cylinder vent hole 525 facing the inner cylinder vent hole 535 and the suction chamber 54 facing this outer cylinder vent hole 525, and this opening 515 sucks air.

In such a configuration, a suction width in which the suction roller 5 sucks the printing medium M can be changed by adjusting the rotational position of the inner cylinder 53 in the rotation direction Dr to switch the inner cylinder vent hole formation range Ri facing the outer cylinder vent hole formation range Ro among the first, second and third inner cylinder vent hole formation ranges Ri1, Ri2 and Ri3.

That is, in FIG. 3A, the rotational position of the inner cylinder 53 in the rotation direction Dr is so adjusted that the first inner cylinder vent hole formation range Ri1 faces the outer cylinder vent hole formation range Ro. Thus, the respective outer cylinder vent holes 525 facing the respective inner cylinder vent holes 535 in the first inner cylinder vent hole formation range Ri1 suck air via the suction chambers 54 and the openings 515 communicating with these outer cylinder vent holes 525, with the result that air is sucked in the first suction range Rs1.

In FIG. 3B, the rotational position of the inner cylinder 53 in the rotation direction Dr is so adjusted that the second inner cylinder vent hole formation range Ri2 faces the outer cylinder vent hole formation range Ro. Thus, the respective outer cylinder vent holes 525 facing the respective inner cylinder vent holes 535 in the second inner cylinder vent hole formation range Ri2 suck air via the suction chambers 54 and the openings 515 communicating with these outer cylinder vent holes 525, with the result that air is sucked in a second suction range Rs2 narrower than the first suction range Rs1.

In FIG. 3C, the rotational position of the inner cylinder 53 in the rotation direction Dr is so adjusted that the third inner cylinder vent hole formation range Ri3 faces the outer cylinder vent hole formation range Ro. Thus, the respective outer cylinder vent holes 525 facing the respective inner cylinder vent holes 535 in the third inner cylinder vent hole formation range Ri3 suck air via the suction chambers 54 and the openings 515 communicating with these outer cylinder vent holes 525, with the result that air is sucked in a third suction range Rs3 narrower than the second suction range Rs2.

As described here, the first, second and third suction ranges Rs1, Rs2 and Rs3 have widths different from each other in the axial direction Da, the first suction range Rs1 includes the second suction range Rs2, and the second suction range Rs2 includes the third suction range Rs3. Therefore, the suction range for sucking the printing medium M can be appropriately used among the first, second and third suction ranges Rs1, Rs2 and Rs3 according to a width of the printing medium M in the axial direction Da.

Further, the suction roller 5 comprises side plates 55 closing between the cylindrical roller 51 and the outer cylinder 52. The side plates 55 are mounted on the outer cylinder 52, and the cylindrical roller body 511 is rotatable in the rotation direction Dr with respect to the side plates 55.

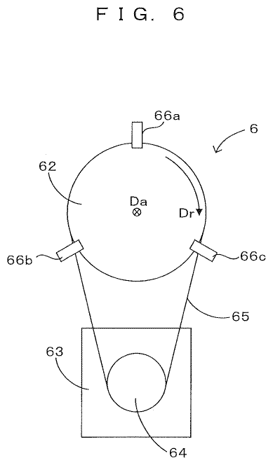

Further, the suction roller 5 comprises a side plate 57 mounted on the other end of the inner cylinder 53 to close the other end of the hollow part 532 of the inner cylinder 53 (i.e. the other end opposite to the one end where the suction port 536 is formed). Further, a shaft 61 and a pulley 62 included in an inner cylinder rotation mechanism 6 (FIG. 6) to be described later are mounted on this side plate 57. Specifically, the shaft 61 projects toward the other side in the axial direction Da from the side plate 57, and the pulley 62 is mounted on the other end of the shaft 61. These side plate 57, shaft 61 and pulley 62 rotate in the rotation direction Dr, integrally with the inner cylinder 53.

In the above configuration, in an overlapping region where the outer cylinder vent hole 525 and the inner cylinder vent hole 535 overlap, air is allowed to flow from the suction chamber 54 into the hollow part 532 of the inner cylinder 53. Therefore, a suction pressure of the suction roller 5 to suck air depends on the size of the overlapping region. On the other hand, in this embodiment, the size of the overlapping region differs according to the axial direction Da of the suction roller 5.

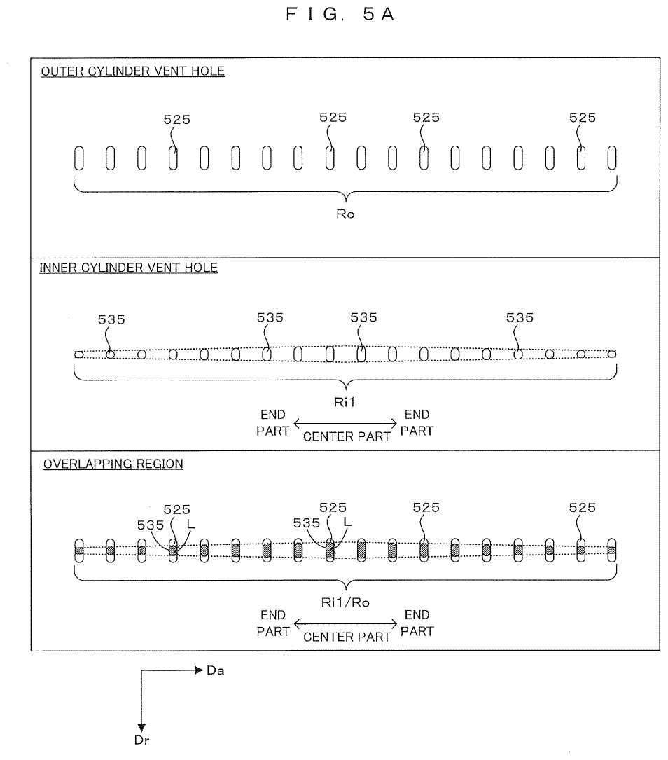

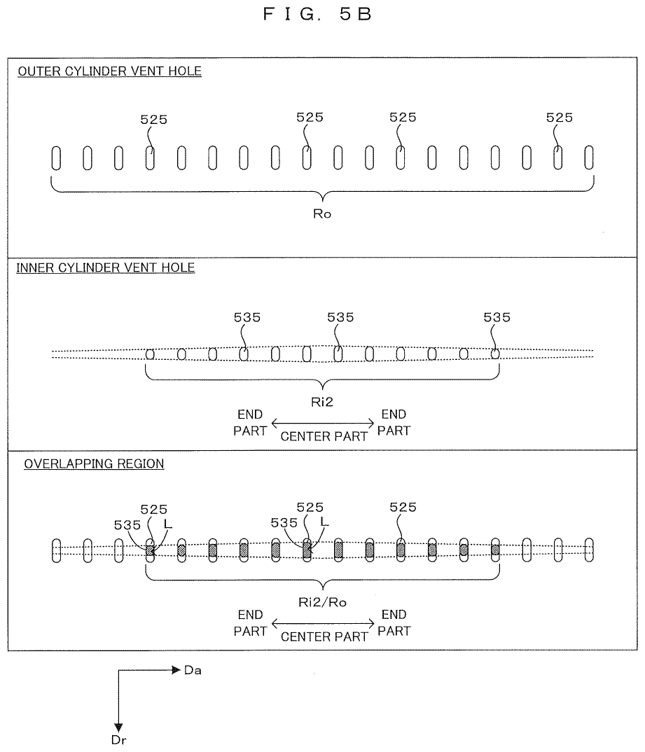

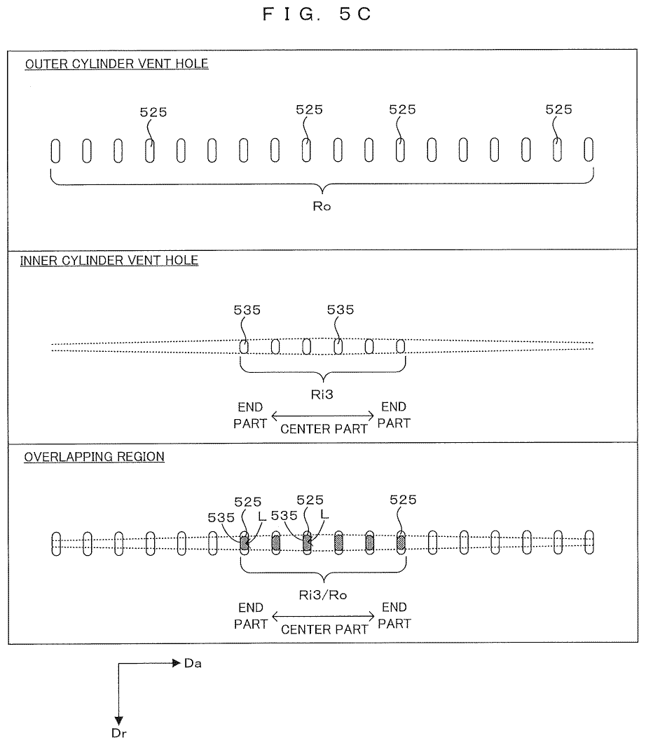

FIG. 5A is a chart schematically showing the size of each overlapping region formed by the inner cylinder vent hole provided in the first inner cylinder vent hole formation range and the outer cylinder vent hole. In FIG. 5A, a broken line is a virtual line added to show differences in the lengths of the inner cylinder vent holes 535 according to the axial direction Da and does not actually exist.

As shown in field “Outer Cylinder Vent Holes” of FIG. 5A, the plurality of outer cylinder vent holes 525 are arranged in a row in parallel to the axial direction Da in the outer cylinder 52. Each outer cylinder vent hole 525 has the same width in the axial direction Da and the same length in the rotation direction Dr. As shown in field “Inner Cylinder Vent Holes” of FIG. 5A, the plurality of inner cylinder vent holes 535 are arranged in a row in parallel to the axial direction Da in the first inner cylinder vent hole formation range Ri1 in the inner cylinder 53. Each inner cylinder vent hole 535 has a length depending on the position thereof in the rotation direction Dr while having the same width in the axial direction Da. That is, the length of the inner cylinder vent hole 535 in the rotation direction Dr becomes shorter from a central part toward end parts of the first inner cylinder vent hole formation range Ri1 in the axial direction Da.

Further, as shown in field “Overlapping Regions” of FIG. 5A, if the first inner cylinder vent hole formation range Ri1 faces the outer cylinder vent hole formation range Ro, the outer cylinder vent holes 525 and the inner cylinder vent holes 535 face each other. As a result, air can pass through the outer cylinder vent holes 525 and the inner cylinder vent holes 535 in overlapping regions L where the outer cylinder vent holes 525 and the inner cylinder vent holes 535 overlap. Further, since the inner cylinder vent hole 535 has the above length in the rotation direction Dr, each overlapping region L has a length corresponding to the position thereof in the rotation direction Dr. That is, the length of the overlapping region L in the rotation direction Dr becomes shorter from the central part toward the end parts of the first inner cylinder vent hole formation range Ri1 in the axial direction Da.

FIG. 5B is a chart schematically showing the size of each overlapping region formed by the inner cylinder vent hole provided in the second inner cylinder vent hole formation range and the outer cylinder vent hole. In FIG. 5B, a broken line is a virtual line added to show differences in the lengths of the inner cylinder vent holes 535 according to the axial direction Da and does not actually exist. As shown in field “Inner Cylinder Vent Holes” of FIG. 5B, the plurality of inner cylinder vent holes 535 are arranged in a row in parallel to the axial direction Da in the second inner cylinder vent hole formation range Ri2 in the inner cylinder 53. Each inner cylinder vent hole 535 has a length depending on the position thereof in the rotation direction Dr while having the same width in the axial direction Da. That is, the length of the inner cylinder vent hole 535 in the rotation direction Dr becomes shorter from a central part toward end parts of the second inner cylinder vent hole formation range Ri2 in the axial direction Da.

Further, as shown in field “Overlapping Regions” of FIG. 5B, if the second inner cylinder vent hole formation range Ri2 faces the outer cylinder vent hole formation range Ro, the outer cylinder vent holes 525 and the inner cylinder vent holes 535 face each other. As a result, air can pass through the outer cylinder vent holes 525 and the inner cylinder vent holes 535 in overlapping regions L where the outer cylinder vent holes 525 and the inner cylinder vent holes 535 overlap. Further, since the inner cylinder vent hole 535 has the above length in the rotation direction Dr, each overlapping region L has a length corresponding to the position thereof in the rotation direction Dr. That is, the length of the overlapping region L in the rotation direction Dr becomes shorter from the central part toward the end parts of the second inner cylinder vent hole formation range Ri2 in the axial direction Da.

FIG. 5C is a chart schematically showing the size of each overlapping region formed by the inner cylinder vent hole provided in the third inner cylinder vent hole formation range and the outer cylinder vent hole. In FIG. 5C, a broken line is a virtual line added to show differences in the lengths of the inner cylinder vent holes 535 according to the axial direction Da and does not actually exist. As shown in field “Inner Cylinder Vent Holes” of FIG. 5C, the plurality of inner cylinder vent holes 535 are arranged in a row in parallel to the axial direction Da in the third inner cylinder vent hole formation range Ri3 in the inner cylinder 53. Each inner cylinder vent hole 535 has a length depending on the position thereof in the rotation direction Dr while having the same width in the axial direction Da. That is, the length of the inner cylinder vent hole 535 in the rotation direction Dr becomes shorter from a central part toward end parts of the third inner cylinder vent hole formation range Ri3 in the axial direction Da.

Further, as shown in field “Overlapping Regions” of FIG. 5C, if the third inner cylinder vent hole formation range Ri3 faces the outer cylinder vent hole formation range Ro, the outer cylinder vent holes 525 and the inner cylinder vent holes 535 face each other. As a result, air can pass through the outer cylinder vent holes 525 and the inner cylinder vent holes 535 in overlapping regions L where the outer cylinder vent holes 525 and the inner cylinder vent holes 535 overlap. Further, since the inner cylinder vent hole 535 has the above length in the rotation direction Dr, each overlapping region L has a length corresponding to the position thereof in the rotation direction Dr. That is, the length of the overlapping region L in the rotation direction Dr becomes shorter from the central part toward the end parts of the third inner cylinder vent hole formation range Ri3 in the axial direction Da.

Further, as understood from FIGS. 4 and 5A to 5C, the length of each inner cylinder vent hole 535 is shorter than that of the outer cylinder vent hole 525 in the rotation direction Dr. Accordingly, a mechanical play corresponding to a difference between the length of the outer cylinder vent hole 525 and that of the inner cylinder vent hole 535 is provided. If a position shift of the inner cylinder vent hole 535 with respect to the outer cylinder vent hole 525 is within the range of this play, the length in the rotation direction Dr of the overlapping region L formed by these outer cylinder vent hole 525 and the inner cylinder vent hole 535 does not change.

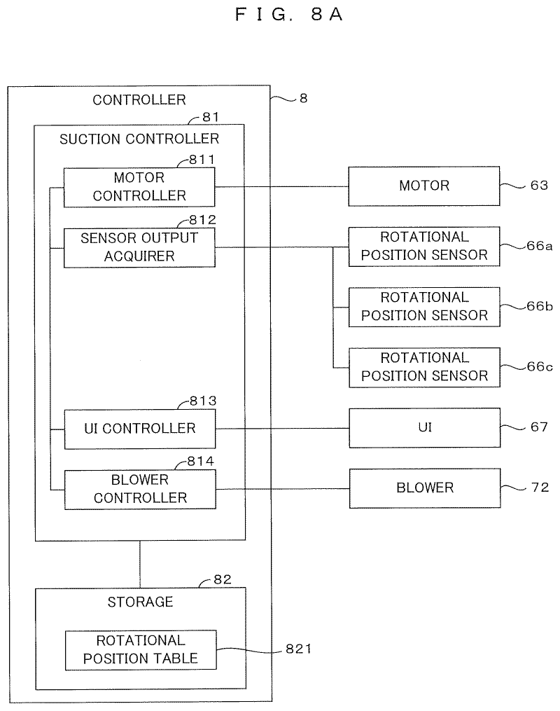

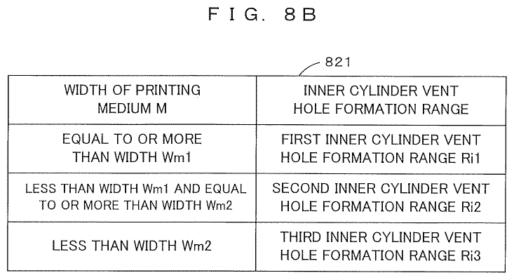

Furthermore, the ink-jet printer 3 is provided with the inner cylinder rotation mechanism 6 (FIG. 6) configured to rotate the inner cylinder 53 of the suction roller 5 and a suction mechanism 7 configured to suck the suction port 536 of the inner cylinder 53 of the suction roller 5 for sucking the printing member M by the suction roller 5 while switching the suction range of the suction roller 5 to suck the printing member among the first, second and third suction ranges Rs1, Rs2 and Rs3. Here, FIG. 6 is a diagram schematically showing an example of the inner cylinder rotation mechanism, FIG. 7 is a diagram schematically showing the suction mechanism configured to suck the suction port of the suction roller, and FIG. 8A is a block diagram showing an electrical configuration of a controller configured to control the operations of the inner cylinder rotation mechanism and the suction mechanism.

The inner cylinder rotation mechanism 6 includes the shaft 61 and the pulley 62 configured to rotate integrally with the inner cylinder 53 of the suction roller 5 as described above. Further, the inner cylinder rotation mechanism 6 includes a motor 63, a pulley 64 to be rotated by the motor 63 about a center of rotation parallel to the axial direction Da, and an endless belt 65 mounted on the pulleys 64 and 62. Therefore, if the motor 63 rotates the pulley 64, the rotation of the pulley 64 is transmitted to the pulley 62 by the endless belt 65 and the inner cylinder 53 of the suction roller 5 rotates according to the rotation of the pulley 62.

Further, the inner cylinder rotation mechanism 6 includes three rotational position sensors 66a, 66b and 66c centered on the axial direction Da and arranged at angular intervals of 120° in the rotation direction Dr. The pulley 62 functions as a sensor dog of the rotational position sensors 66a, 66b and 66c, and the rotational position sensors 66a, 66b and 66c output signals corresponding to the rotational position of the pulley 62. In an example here, the pulley 62 includes a slit provided at a rotational position corresponding to the first inner cylinder vent hole formation range Ri1. On the other hand, the rotational position sensors 66a, 66b and 66c are optical sensors detecting the slit. That is, the rotational position sensors 66a, 66b and 66c output an ON signal when detecting the slit, and output an OFF signal when not detecting the slit. Accordingly, when the first inner cylinder vent hole formation range Ri1 faces the outer cylinder vent hole formation range Ro, the rotational position sensor 66a outputs an ON signal, whereas the rotational position sensors 66b, 66c output an OFF signal. When the second inner cylinder vent hole formation range Ri2 faces the outer cylinder vent hole formation range Ro, the rotational position sensor 66b outputs an ON signal, whereas the rotational position sensors 66c, 66a output an OFF signal. When the third inner cylinder vent hole formation range Ri3 faces the outer cylinder vent hole formation range Ro, the rotational position sensor 66c outputs an ON signal, whereas the rotational position sensors 66a, 66b output an OFF signal.

Accordingly, the rotational position of the inner cylinder 53 can be detected based on the output signals (ON signal/OFF signals) of the respective rotational position sensors 66a, 66b and 66c. However, a specific mechanism for detecting the rotational position of the inner cylinder 53 is not limited to the example here. For example, the position of the slit in the pulley 62 may be changed as appropriate. Alternatively, instead of the optical sensors, contact-type sensors may be used as the rotational position sensors 66a, 66b and 66c. In this case, the rotational position of the inner cylinder 53 can be detected based on a detection result of a projection provided on the pulley 62 instead of the slit by the contact-type rotational position sensors 66a, 66b and 66c.

As shown in FIG. 7, the suction mechanism 7 includes a connection pipe 71, and a suction path 711 is formed in the connection pipe 71. One end of the suction path 711 is connected to the suction port 536 of the inner cylinder 53. Further, the suction mechanism 7 includes the blower 72, and the other end of the suction path 711 is connected to the blower 72. Therefore, if the blower 72 rotates to exhaust the inside of the suction path 711 of the connection pipe 71, a suction force corresponding to a rotation speed of the blower 72 is given to the suction port 536 of the inner cylinder 53.

Further, as shown in FIG. 8A, the ink-jet printer 3 comprises a controller 8. This controller 8 includes a suction controller 81 and a storage 82. The suction controller 81 is, for example, a processor such as a CPU (Central Processing Unit), and the storage 82 is, for example, a storage device such as a SSD (Slide State Drive). The suction controller 81 includes a motor controller 811 configured to control the motor 63 and a sensor output acquirer 812 configured to acquire signals output by the rotational position sensors 66a, 66b and 66c. The output signals of the rotational position sensors 66a, 66b and 66c acquired by the sensor output acquirer 812 are transmitted to the motor controller 811. The motor controller 811 controls the rotational position of the motor 63 based on the output signals received from the sensor output acquirer 812. Particularly, the rotational position of the motor 63 is controlled based on the width of the printing medium M in the axial direction Da by the motor controller 811.

That is, the ink-jet printer 3 comprises a UI (User Interface) 67. The UI 67 includes an input device such as a mouse or keyboard, and an output device such as a display. Note that the input device and the output device of the UI 67 need not be separately configured, and these may be integrally configured by a touch panel display or the like. On the other hand, the controller 8 includes a UI controller 813 configured to control the UI 67. The UI controller 813 controls the UI 67 such that an input screen for inputting the width of the printing medium M set in the ink-jet printer 3 (i.e. the width of the printing medium M supported by the conveyor 4) is displayed on the display. Therefore, an operator can input the width of the printing medium M to the UI 67 by operating the input device of the UI 67. Then, the UI controller 813 obtains the width of the printing medium M input to the UI 67.

Further, a rotational position table 821 (FIG. 8B) showing a relationship between the width of the printing medium M and the rotational position of the inner cylinder 53 is stored in the storage 82. FIG. 8B shows an example of the rotational position table. This rotational position table 821 shows a relationship between the width of the printing medium M and the inner cylinder vent hole formation range caused to face the outer cylinder vent hole formation range Ro to suck the printing medium M.

If the width of the printing medium M input to the UI 67 is equal to or more than a width Wm1, the motor controller 811 controls the motor 63 such that the motor 63 positions the inner cylinder 53 to a rotational position where the first inner cylinder vent hole formation range Ri1 faces the outer cylinder vent hole formation range Ro. In this way, as shown in FIG. 5A, the printing medium M is sucked by the suction roller 5 in the first suction range Rs1 corresponding to the first inner cylinder vent hole formation range Ri1.

If the width of the printing medium M input to the UI 67 is less than the width Wm1 and equal to or more than a width Wm2 (shorter than the width Wm1), the motor controller 811 controls the motor 63 such that the motor 63 positions the inner cylinder 53 to a rotational position where the second inner cylinder vent hole formation range Ri2 faces the outer cylinder vent hole formation range Ro. In this way, as shown in FIG. 5B, the printing medium M is sucked by the suction roller 5 in the second suction range Rs2 corresponding to the second inner cylinder vent hole formation range Ri2.

If the width of the printing medium M input to the UI 67 is less than the width Wm2, the motor controller 811 controls the motor 63 such that the motor 63 positions the inner cylinder 53 to a rotational position where the third inner cylinder vent hole formation range Ri3 faces the outer cylinder vent hole formation range Ro. In this way, as shown in FIG. 5C, the printing medium M is sucked by the suction roller 5 in the third suction range Rs3 corresponding to the third inner cylinder vent hole formation range Ri3.

By the way, in causing the first inner cylinder vent hole formation range Ri1 to face the outer cylinder vent hole formation range Ro, the motor controller 811 controls the rotational position of the motor 63 such that an ON signal is output from the rotational position sensor 66a corresponding to the first inner cylinder vent hole formation range Ri1, out of the rotational position sensors 66a to 66c. Also in causing the second or third inner cylinder vent hole formation range Ri2, Ri3 to face the outer cylinder vent hole formation range Ro, a similar control is executed by the motor controller 811.

Further, the suction controller 81 includes a blower controller 814 configured to control the blower 72. This blower controller 814 controls the blower 72 such that the blower 72 generates a predetermined suction force in the suction port 536 of the inner cylinder 53.

The suction roller 5 configured as described above is provided with the cylindrical roller 51, the outer cylinder 52 inserted in the cylindrical roller 51 and the plurality of suction chambers 54 formed to be arranged in the axial direction Da (longitudinal direction) between the inner peripheral surface 514 of the cylindrical roller 51 and the outer peripheral surface 513 of the outer cylinder 52. The plurality of openings 515 for sucking and supporting the printing medium M (base material) are formed in the outer peripheral surface 513 of the cylindrical roller 51, and the cylindrical roller 51 is configured such that each of the plurality of openings 515 communicates with the corresponding one of the plurality of suction chambers 54. Further, the outer cylinder vent holes 525, through which air can pass, are formed in the outer peripheral surface 523 of the outer cylinder 52. Further, the inner cylinder 53 is inserted in this outer cylinder 52, and the inner cylinder vent holes 535, through which air can pass, are formed in the outer peripheral surface 533 of the inner cylinder 53. The overlapping regions L are formed by overlapping the outer cylinder vent holes 525 and the inner cylinder vent holes 535. If the suction port 536 of the inner cylinder 53 receives a suction force from the blower 72 (suction source), air is sucked toward the suction port 536 from the suction chamber 54 facing the overlapping region L of the inner cylinder vent hole 535 and the outer cylinder vent hole 525, out of the plurality of suction chambers 54, via the overlapping region L. Moreover, the outer cylinder 52 and the inner cylinder 53 are so configured that the overlapping region L becomes narrower in the rotation direction Dr from the center toward the both ends in the axial direction Da (FIGS. 5A, 5B and 5C). Thus, a pressure of the cylindrical roller 51 to suck the printing medium M is reduced from the center toward the ends of the cylindrical roller 51. In other words, the cylindrical roller 51 sucks the printing medium M with a strong pressure in the central part of the cylindrical roller 51, and sucks the printing medium M with a pressure lower than that in the central part of the cylindrical roller 51 in both end parts of the cylindrical roller 51. Therefore, even if the printing medium M in contact with the central part of the cylindrical roller 51 is creased, the crease of the printing medium M is corrected along the outer peripheral surface 513 of the cylindrical roller 51 since the printing medium M is sucked with a strong pressure in the central part of the cylindrical roller 51. Further, since the printing medium M is sucked with a weak pressure in the both end parts of the cylindrical roller 51, both end parts of the printing medium M can be shifted in the axial direction Da according to the crease correction of the printing medium M in the central part. In this way, the crease of the printing medium M is stretched in the axial direction Da. As a result, a problem of creasing the printing medium M sucked by the suction roller 5 can be solved.

Further, in the above ink-jet printer 3, if data representing the width of the printing medium M is input to the UI 67 (input part), the motor 63 is controlled by the motor controller 811 such that the suction range of the suction roller 5 is switched among the first, second and third suction ranges Rs1, Rs2 and Rs3 corresponding to the width of the printing medium M. Therefore, the operator can change the suction range (suction width) of the suction roller 5 only by performing an operation of inputting the data representing the width of the printing medium M to the UI 67. As a result, a problem of reducing a burden required for an operation of changing the suction width of the suction roller 5 can be solved.

Further, the suction roller 5 is arranged at such a position (position of the roller 471) as to be able to suck and convey the printing medium M immediately after a color image is printed by the color printing part 32 (i.e. the printing medium M immediately after being carried out from the color conveyor 45) (FIG. 2). In such a configuration, the printing medium M immediately after the color image is printed thereon can be stably supported by the suction roller 5 (roller 471).

Further, the suction roller 5 is arranged at such a position (position of the roller 491) as to be able to suck and convey the printing medium M immediately after a white image is printed by the white printing part 33 (i.e. the printing medium M immediately after being carried out from the white conveyor 48) (FIG. 2). In such a configuration, the printing medium M immediately after the white image is printed thereon can be stably supported by the suction roller 5 (roller 491).

Further, in the outer peripheral surface 533 of the inner cylinder 53, the first, second and third inner cylinder vent hole formation ranges Ri1, Ri2 and Ri3 (a plurality of inner cylinder vent hole formation ranges) having widths different from each other in the axial direction Da are provided at the rotational positions different in the rotation direction Dr. By changing the inner cylinder vent hole formation range at the position facing the outer cylinder vent holes 525, out of the first, second and third inner cylinder vent hole formation ranges Ri1, Ri2 and Ri3, the width in the axial direction Da, over which the overlapping regions L are formed, can be changed and the suction range of the cylindrical roller 51 to suck the printing medium M can be changed among the first, second and third inner cylinder vent hole formation ranges Ri1, Ri2 and Ri3. That is, the motor 63 (switching part) can switch the suction range (suction width) for sucking the printing medium M by rotating the inner cylinder 53 to switch the inner cylinder vent hole formation range facing the outer cylinder vent holes 525, out of the first, second and third inner cylinder vent hole formation ranges Ri1, Ri2 and Ri3. Moreover, in the rotation direction Dr, the length of the outer cylinder vent hole 525 is longer than the length of the inner cylinder vent hole 535, out of the outer cylinder vent hole 525 and the inner cylinder vent hole 535 (FIG. 4). Thus, even if the positions of the inner cylinder vent holes 535 caused to face the outer cylinder vent holes 525 are slightly shifted in the rotation direction, the overlapping regions L of a desired length can be formed. As a result, positioning accuracy required for the motor controller 811 (switching controller) configured to control the motor 63 rotating the inner cylinder 53 in the rotation direction Dr is not high, and the suction width of the printing medium M by the suction roller 5 can be switched by a simple control.

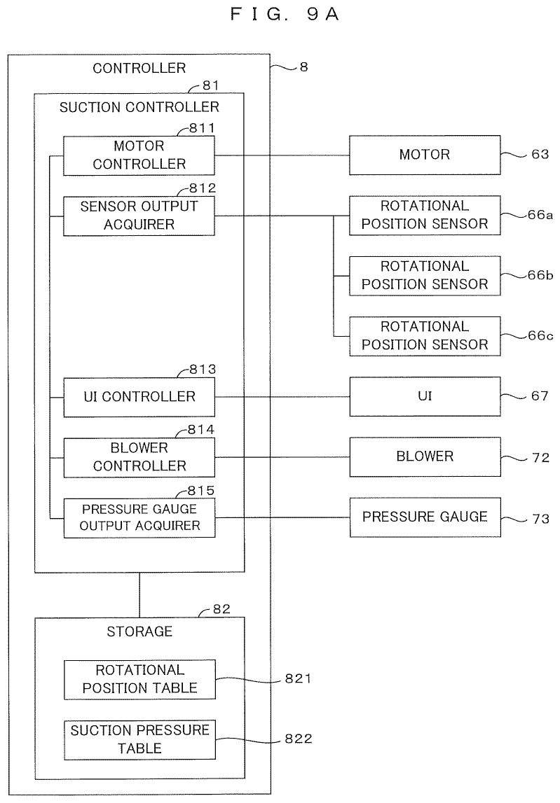

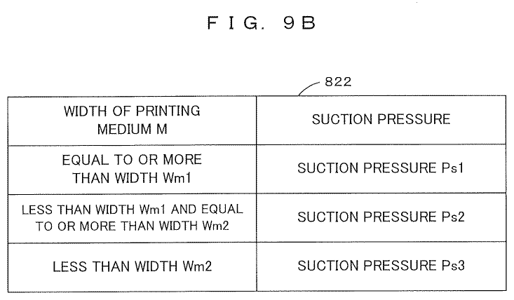

In the above example, the suction range for sucking the printing medium M is switched according to the width of the printing medium M. At this time, the suction force for sucking the printing medium M can be controlled according to the width of the printing medium M. FIG. 9A is a block diagram showing an electrical configuration of a controller according to a modification. In this modification, the suction mechanism 7 includes a pressure gauge 73 configured to measure a pressure applied to the suction port 536 and outputting this pressure. On the other hand, the controller 8 includes a pressure gauge output acquirer 815 configured to acquire the pressure output by the pressure gauge 73. The pressure is controlled based on the width of the printing medium M in the axial direction Da by the blower controller 814.

That is, as described above, the operator can input the width of the printing medium M to the UI 67 by operating the input device of the UI 67. Then, the UI controller 813 obtains the width of the printing medium M input to the UI 67. On the other hand, a suction pressure table 822 (FIG. 9B) showing a relationship between the width of the printing medium M and the suction pressure for sucking the suction port 536 is stored in the storage 82. FIG. 9B shows an example of the suction pressure table. This suction pressure table 822 shows the relationship between the width of the printing medium M and the suction pressure to be generated in the suction port 536 to suck the printing medium M. Such a suction pressure table 822 is, for example, obtained by empirically measuring a suction pressure optimal to suck the printing medium M by the suction roller 5 while changing the width of the printing medium M.

The blower controller 814 controls the blower 72 according to a result of reading the suction pressure corresponding to the input width of the printing medium M from the suction pressure table 822. That is, if the width of the printing medium M input to the UI 67 is equal to or more than the width Wm1, the blower controller 814 controls the blower 72 such that the pressure acquired from the pressure gauge 73 by the pressure gauge output acquirer 815 becomes a suction pressure Ps1. If the width of the printing medium M input to the UI 67 is less than the width Wm1 and equal to or more than the width Wm2 (shorter than the width Wm1), the blower controller 814 controls the blower 72 such that the pressure acquired from the pressure gauge 73 by the pressure gauge output acquirer 815 becomes a suction pressure Ps2. Further, if the width of the printing medium M input to the UI 67 is less than the width Wm2, the blower controller 814 controls the blower 72 such that the pressure acquired from the pressure gauge 73 by the pressure gauge output acquirer 815 becomes a suction pressure Ps3.

In such a modification, the storage 82 is provided which stores widths of a plurality of printing mediums M and values of suction pressures (suction forces) for sucking the suction port 536 of the suction roller 5 by the blower 72 (suction part) in association with each other. On the other hand, the blower controller 814 of the controller 8 reads out the corresponding suction pressure Ps1 to Ps3 from the storage 82 according to the width of the printing medium M input to the UI 67 (input part) and controls the blower 72 to suck the suction port 536 of the suction roller 5 with the read-out suction pressure. In such a configuration, the printing medium M can be appropriately sucked with a suction pressure corresponding to a characteristic of the printing medium M.

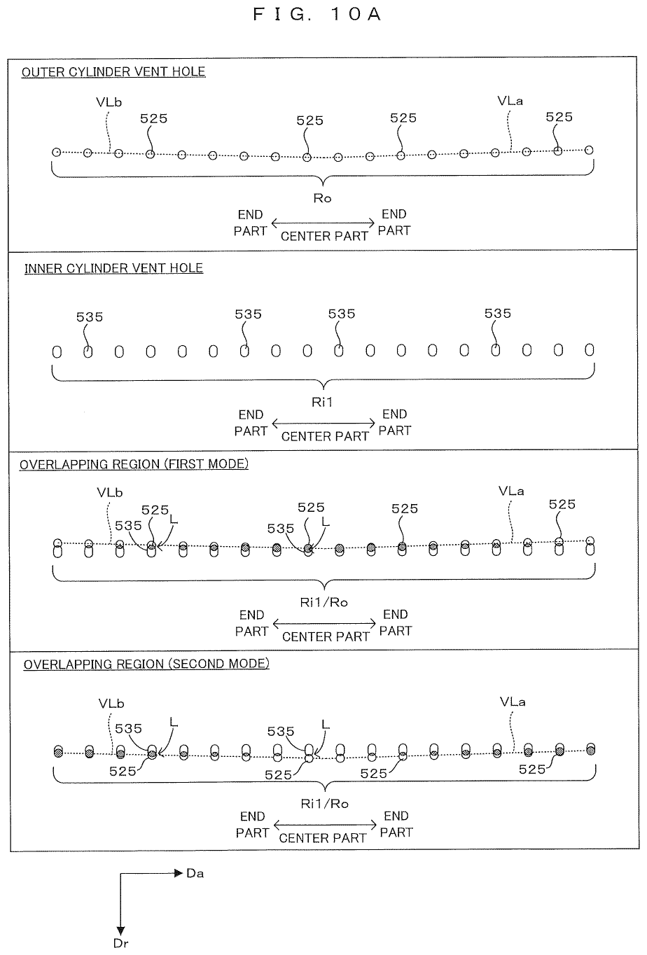

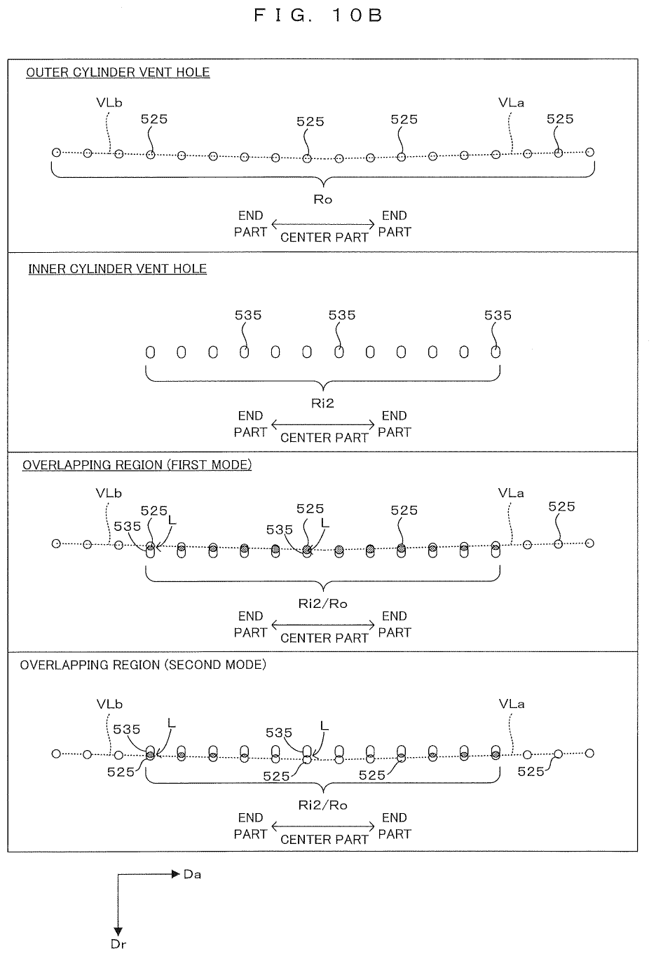

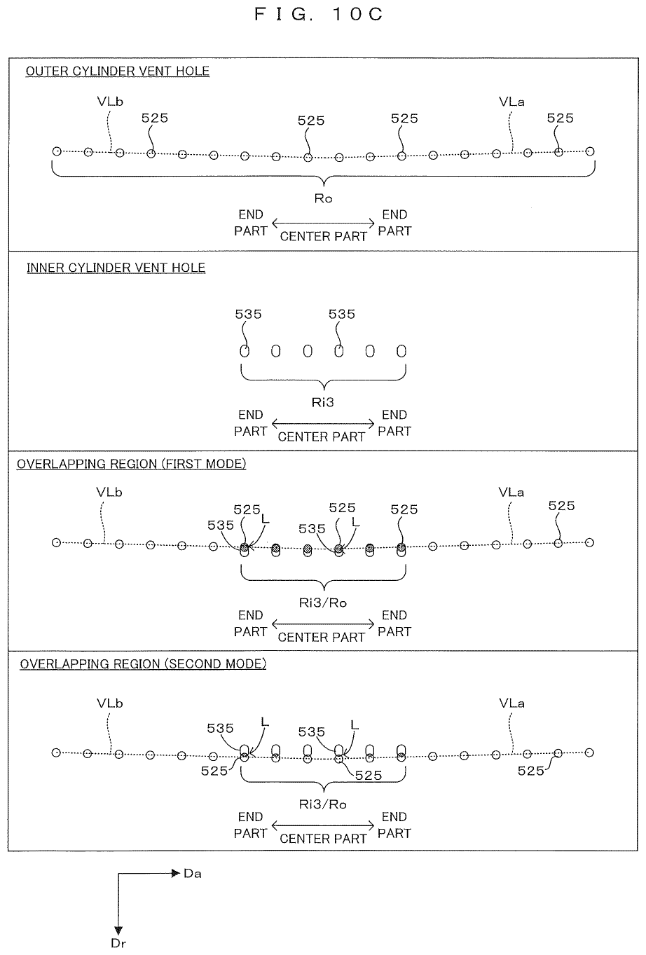

FIG. 10A is a chart schematically showing the size of each overlapping region formed by the outer cylinder vent hole and the inner cylinder vent hole provided in the first inner cylinder vent hole formation range in the modification. In FIG. 10A, a broken line is a virtual line added to show an arrangement direction of the outer cylinder vent holes 525 and does not actually exist.

As shown in field “Outer Cylinder Vent Holes” of FIG. 10A, the plurality of outer cylinder vent holes 525 are arrayed in the axial direction Da in the outer cylinder 52. However, an array direction of the plurality of outer cylinder vent holes 525 is not parallel to the axial direction Da, but is inclined with respect to the axial direction Da. Specifically, the plurality of outer cylinder vent holes 525 include the outer cylinder vent holes 525 arrayed along a virtual inclined straight line VLa inclined to the axial direction Da from a center toward one end (right end in FIG. 10A) of the outer cylinder 52 in the axial direction Da and the outer cylinder vent holes 525 arrayed along a virtual inclined straight line VLb inclined to the axial direction Da from the center toward the other end (left end in FIG. 10A) of the outer cylinder 52 in the axial direction Da. Here, the virtual inclined straight lines VLa, VLb are inclined opposite to each other and constitute a V shape. Each outer cylinder vent hole 525 has the same width in the axial direction Da and the same length in the rotation direction Dr.

As shown in field “Inner Cylinder Vent Holes” of FIG. 10A, the plurality of inner cylinder vent holes 535 are arranged in a row in parallel to the axial direction Da in the first inner cylinder vent hole formation range Ri1 in the inner cylinder 53. Each inner cylinder vent hole 535 has the same width in the axial direction Da and the same length in the rotation direction Dr. Note that the inner cylinder vent holes 535 are longer than the outer cylinder vent holes 525 in the rotation direction Dr.

Further, as shown in fields “Overlapping Regions (First Mode)” and “Overlapping Regions (Second Mode)” of FIG. 10A, if the first inner cylinder vent hole formation range Ri1 faces the outer cylinder vent hole formation range Ro, the outer cylinder vent holes 525 and the inner cylinder vent holes 535 face each other. As a result, air can pass through the outer cylinder vent holes 525 and the inner cylinder vent holes 535 in overlapping regions L where the outer cylinder vent holes 525 and the inner cylinder vent holes 535 overlap. Further, since the outer cylinder vent holes 525 are arrayed into a V shape as described above, each overlapping region L has a length corresponding to the position thereof in the rotation direction Dr. Specifically, in the first mode, the length of the overlapping region L in the rotation direction Dr becomes shorter from the central part toward the end parts of the first inner cylinder vent hole formation range Rib in the axial direction Da. On the other hand, in the second mode, the length of the overlapping region L in the rotation direction Dr becomes longer from the central part toward the end parts of the first inner cylinder vent hole formation range Ri1 in the axial direction Da. As just described, in an example of FIG. 10A, suction by the suction roller 5 can be performed by adjusting the position of the inner cylinder 53 in the rotation direction Dr with respect to the outer cylinder 52 to switch between the first and second modes.

FIG. 10B is a chart schematically showing the size of each overlapping region formed by the outer cylinder vent hole and the inner cylinder vent hole provided in the second inner cylinder vent hole formation range in the modification. In FIG. 10B, a broken line is a virtual line added to show the arrangement direction of the outer cylinder vent holes 525 and does not actually exist.

As shown in field “Inner Cylinder Vent Holes” of FIG. 10B, the plurality of inner cylinder vent holes 535 are arranged in a row in parallel to the axial direction Da in the second inner cylinder vent hole formation range Ri2 in the inner cylinder 53. Each inner cylinder vent hole 535 has the same width in the axial direction Da and the same length in the rotation direction Dr. Note that the inner cylinder vent holes 535 are longer than the outer cylinder vent holes 525 in the rotation direction Dr.

Further, as shown in fields “Overlapping Regions (First Mode)” and “Overlapping Regions (Second Mode)” of FIG. 10B, if the second inner cylinder vent hole formation range Ri2 faces the outer cylinder vent hole formation range Ro, the outer cylinder vent holes 525 and the inner cylinder vent holes 535 face each other. As a result, air can pass through the outer cylinder vent holes 525 and the inner cylinder vent holes 535 in overlapping regions L where the outer cylinder vent holes 525 and the inner cylinder vent holes 535 overlap. Further, since the outer cylinder vent holes 525 are arrayed into a V shape as described above, each overlapping region L has a length corresponding to the position thereof in the rotation direction Dr. Specifically, in the first mode, the length of the overlapping region L in the rotation direction Dr becomes shorter from the central part toward the end parts of the second inner cylinder vent hole formation range Ri2 in the axial direction Da. On the other hand, in the second mode, the length of the overlapping region L in the rotation direction Dr becomes longer from the central part toward the end parts of the second inner cylinder vent hole formation range Ri2 in the axial direction Da. As just described, in an example of FIG. 10B, suction by the suction roller 5 can be performed by adjusting the position of the inner cylinder 53 in the rotation direction Dr with respect to the outer cylinder 52 to switch between the first and second modes.

FIG. 10C is a chart schematically showing the size of each overlapping region formed by the outer cylinder vent hole and the inner cylinder vent hole provided in the third inner cylinder vent hole formation range in the modification. In FIG. 10C, a broken line is a virtual line added to show the arrangement direction of the outer cylinder vent holes 525 and does not actually exist.

As shown in field “Inner Cylinder Vent Holes” of FIG. 10C, the plurality of inner cylinder vent holes 535 are arranged in a row in parallel to the axial direction Da in the third inner cylinder vent hole formation range Ri3 in the inner cylinder 53. Each inner cylinder vent hole 535 has the same width in the axial direction Da and has the same length in the rotation direction Dr. Note that the inner cylinder vent holes 535 are longer than the outer cylinder vent holes 525 in the rotation direction Dr.

Further, as shown in fields “Overlapping Regions (First Mode)” and “Overlapping Regions (Second Mode)” of FIG. 10C, if the third inner cylinder vent hole formation range Ri3 faces the outer cylinder vent hole formation range Ro, the outer cylinder vent holes 525 and the inner cylinder vent holes 535 face each other. As a result, air can pass through the outer cylinder vent holes 525 and the inner cylinder vent holes 535 in overlapping regions L where the outer cylinder vent holes 525 and the inner cylinder vent holes 535 overlap. Further, since the outer cylinder vent holes 525 are arrayed into a V shape as described above, each overlapping region L has a length corresponding to the position thereof in the rotation direction Dr. Specifically, in the first mode, the length of the overlapping region L in the rotation direction Dr becomes shorter from the central part toward the end parts of the third inner cylinder vent hole formation range Ri3 in the axial direction Da. On the other hand, in the second mode, the length of the overlapping region L in the rotation direction Dr becomes longer from the central part toward the end parts of the third inner cylinder vent hole formation range Ri3 in the axial direction Da. As just described, in an example of FIG. 10C, suction by the suction roller 5 can be performed by adjusting the position of the inner cylinder 53 in the rotation direction Dr with respect to the outer cylinder 52 to switch between the first and second modes.

In such a configuration, the motor controller 811 controls the motor 63 and the motor 63 adjusts the rotational position of the inner cylinder 53 in the rotation direction Dr with respect to the outer cylinder 52. In this way, the suction range of the suction roller 5 to suck the printing medium M can be switched among the first, second and third suction ranges Rs1, Rs2 and Rs3 by causing any one of the first, second and third inner cylinder vent hole formation ranges Ri1, Ri2 and Ri3 to face the outer cylinder vent hole formation range Ro. Further, the motor controller 811 controls the motor 63 and the motor 63 adjusts the rotational position of the inner cylinder 53 in the rotation direction Dr with respect to the outer cylinder 52, whereby the first mode in which the length of the overlapping region L in the rotation direction Dr becomes shorter from the central part to the end parts and the second mode in which the length of the overlapping region L in the rotation direction Dr becomes longer from the central part to the end parts can be switchably used.

In the above embodiment, the arrangement directions of the outer cylinder vent holes 525 (extending directions of the virtual inclined straight lines VLa, VLb) and the arrangement direction of the inner cylinder vent holes 535 (axial direction Da) are inclined to each other such that the overlapping region L becomes shorter from the center toward the both ends in the axial direction Da (longitudinal direction). That is, by a relatively simple configuration of inclining the arrangement directions of the outer cylinder vent holes 525 (extending directions of the virtual inclined straight lines VLa, VLb) and the arrangement direction of the inner cylinder vent holes 535 (axial direction Da) to each other, the suction pressure of the cylindrical roller 51 to suck the printing medium M is changed to become stronger in the central part and become weaker in the end parts (first mode), whereby the problem of creasing the printing medium M sucked by the suction roller 4 can be solved.

Further, the inner cylinder 53 is configured to be movable with respect to the outer cylinder 52 in the rotation direction Dr. By moving the inner cylinder 53 in the rotation direction Dr with respect to the outer cylinder 52 and changing a positional relationship of the outer cylinder vent holes 525 and the inner cylinder vent holes 535 in the rotation direction Dr, the length of the overlapping region L in the rotation direction Dr can be adjusted to become narrower from the center toward the both ends in the axial direction Da (first mode). In such a configuration, the crease of the printing medium M sucked by the suction roller 5 can be suppressed by moving the inner cylinder 53 in the rotation direction Dr with respect to the outer cylinder 52 to adjust such that the length of the overlapping region L in the rotation direction becomes narrower from the center toward the both ends in the axial direction Da.

Further, the above suction roller 5 is provided with the cylindrical roller 51, the outer cylinder 52 inserted in the cylindrical roller 51 and the plurality of suction chambers 54 formed to be arranged in the axial direction Da (longitudinal direction) between the inner peripheral surface 514 of the cylindrical roller 51 and the outer peripheral surface 523 of the outer cylinder 52. The plurality of openings 515 for sucking and supporting the printing medium M (base material) are formed in the outer peripheral surface 513 of the cylindrical roller 51, and the cylindrical roller 51 is configured such that each of the plurality of openings 515 communicates with the corresponding one of the plurality of suction chambers 54. Further, the outer cylinder vent holes 525, through which air can pass, are formed in the outer peripheral surface 523 of the outer cylinder 52. Further, the inner cylinder 53 is inserted in this outer cylinder 52, and the inner cylinder vent holes 535, through which air can pass, are formed in the outer peripheral surface 533 of the inner cylinder 53. The overlapping regions L are formed by overlapping the outer cylinder vent holes 525 and the inner cylinder vent holes 535. If the suction port 536 of the inner cylinder 53 receives a suction force from the blower 72 (suction source), air is sucked toward the suction port 536 from the suction chamber 54 facing the overlapping region L of the inner cylinder vent hole 535 and the outer cylinder vent hole 525, out of the plurality of suction chambers 54, via the overlapping regions L. Moreover, the length of the overlapping region L in the rotation direction Dr changes according to the position thereof in the axial direction Da parallel to the axis of rotation A (cylindrical axis). Further, the length of the overlapping region L in the rotation direction Dr can be adjusted by moving the inner cylinder 53 in the rotation direction Dr with respect to the outer cylinder 52 to change the positional relationship between the outer cylinder vent holes 525 and the inner cylinder vent holes 535 in the rotation direction Dr. Therefore, a pressure for sucking the printing medium M can be changed in the axial direction Da according to the characteristic of the printing medium M. As a result, the problem of creasing the printing medium M sucked by the suction roller 5 can be solved.

Further, the suction roller 5 is configured such that the inner cylinder 53 is rotatable in the rotation direction Dr with respect to the outer cylinder 52 and the arrangement directions of the outer cylinder vent holes 525 (extending directions of the virtual inclined straight lines VLa, VLb) and the arrangement direction of the inner cylinder vent holes 535 (axial direction Da) are inclined to each other to change the length of the overlapping region L in the rotation direction Dr according to the position thereof in the axial direction Da. In such a configuration, a pressure for sucking the printing medium M can be changed in the axial direction Da according to the characteristic of the printing medium M by rotating the inner cylinder 53 in the rotation direction Dr with respect to the outer cylinder 52 to adjust the lengths of the overlapping regions L in the rotation direction Dr. As a result, the problem of creasing the printing medium M sucked by the suction roller 5 can be solved.

Incidentally, in the example of FIGS. 10A to 10C, the first and second modes are available as modes for changing the length in the rotation direction Dr of the overlapping region L in the axial direction Da. In the first mode, the length in the rotation direction Dr of the overlapping region L becomes shorter from the central part toward the end parts in the axial direction Da. Therefore, the pressure of the suction roller 5 to suck the printing medium M becomes strong in the central part in the axial direction Da and, on the other hand, becomes weak in the end parts. Thus, the crease of the printing medium M can be suppressed for the aforementioned reason. However, in some cases, the crease of the printing medium M can be effectively suppressed by conversely changing the suction force in the axial direction Da, depending on the characteristic of the printing medium M. Accordingly, in the case of sucking such a printing medium M by the suction roller 5 in this way, the second mode may be selected in which the length of the overlapping region L in the rotation direction Dr becomes longer from the central part toward the end parts in the axial direction Da. For example, the first and second modes can be appropriately used according to the characteristic of the printing medium M by executing the following control.

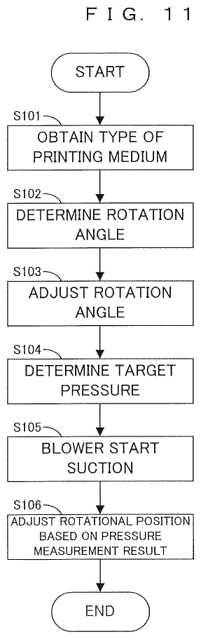

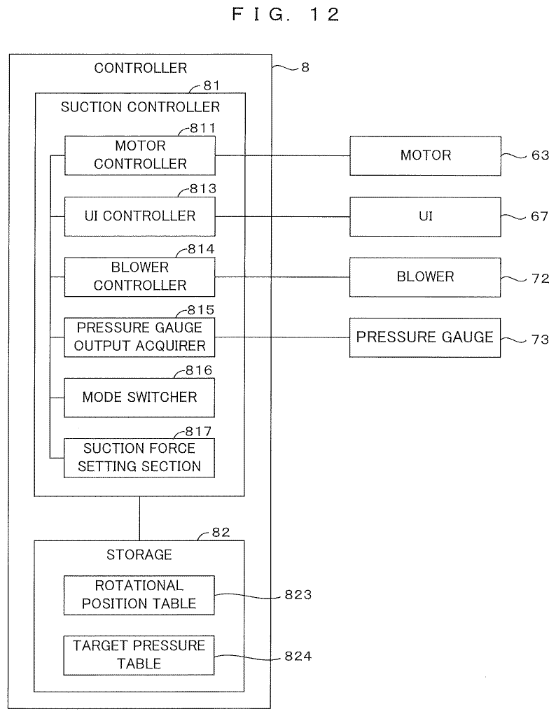

FIG. 11 is a flow chart showing an example of a control executed by the controller. FIG. 12 is a block diagram showing an electrical configuration of the controller for carrying out the flow chart of FIG. 11. In Step S101, the UI controller 813 obtains the type of the printing medium M input to the UI 67 by an operator. The type of the printing medium M obtained by the UI controller 813 is transmitted to the motor controller 811.

The motor controller 811 determines a rotation angle of the inner cylinder 53 based on a rotational position table 823 stored in the storage 82 (Step S102). This rotational position table 823 shows a correspondence relationship between the combination of the width and a material of the printing medium M indicated by the type of the printing medium M obtained by the UI controller 813 and the following six rotation angles:
rotation angle θ1 . . . an angle for forming the overlapping regions L of the first inner cylinder vent hole formation range Ri1 and the outer cylinder vent hole formation range Ro in the first mode,
rotation angle θ2 . . . an angle for forming the overlapping regions L of the first inner cylinder vent hole formation range Ri1 and the outer cylinder vent hole formation range Ro in the second mode,
rotation angle θ3 . . . an angle for forming the overlapping regions L of the second inner cylinder vent hole formation range Ri2 and the outer cylinder vent hole formation range Ro in the first mode,
rotation angle θ4 . . . an angle for forming the overlapping regions L of the second inner cylinder vent hole formation range Ri2 and the outer cylinder vent hole formation range Ro in the second mode,
rotation angle θ5 . . . an angle for forming the overlapping regions L of the third inner cylinder vent hole formation range Ri3 and the outer cylinder vent hole formation range Ro in the first mode,
rotation angle θ6 . . . an angle for forming the overlapping regions L of the third inner cylinder vent hole formation range Ri3 and the outer cylinder vent hole formation range Ro in the second mode.
   In Step S103, the motor controller 811 controls the motor 63 such that the motor 63 adjusts the rotation angle of the inner cylinder 53 to the rotation angle determined in Step S102.

Further, the motor controller 811 determines a target pressure in the suction port 536 of the inner cylinder 53 based on a target pressure table 824 stored in the storage 82 (Step S104). This target pressure table 824 shows a correspondence relationship between the type of the printing medium M and the target pressure. In Step S105, the blower controller 814 controls the blower 72 such that the blower 72 starts the suction of the suction port 536 of the inner cylinder 53 (Step S105).

In Step S106, the motor controller 811 controls the motor 63 such that a pressure measurement result acquired from the pressure gauge 73 by the pressure gauge output acquirer 815 becomes the target pressure. In this way, the lengths (i.e. degrees of openings) of the overlapping regions L in the rotation direction Dr are adjusted. That is, an appropriate value of the suction pressure in sucking the printing medium M can be changed according to the material and the like of the printing medium M. Accordingly, the printing medium M can be sucked with an appropriate suction pressure by adjusting the degrees of opening of the overlapping regions L. Further, the target pressure table 824 showing the relationship between the printing medium M and the appropriate suction pressure is empirically obtained in advance.

In an example of FIGS. 11 and 12, the suction controller 81 (controller) includes the motor controller 811 (rotation controller) configured to control a rotation amount of the inner cylinder 53 in the rotation direction Dr with respect to the outer cylinder 52 based on the value of the suction force measured by the pressure gauge (measuring part). In such a configuration, the crease of the printing medium M can be suppressed by sucking the printing medium M with an appropriate pressure suitable to suppress the crease of the printing medium M.

By the way, specific configurations of the outer cylinder vent holes 525 and the inner cylinder vent holes 535 can be variously changed. Accordingly, the outer cylinder vent holes 525 and the inner cylinder vent holes 535 may be configured as described next.

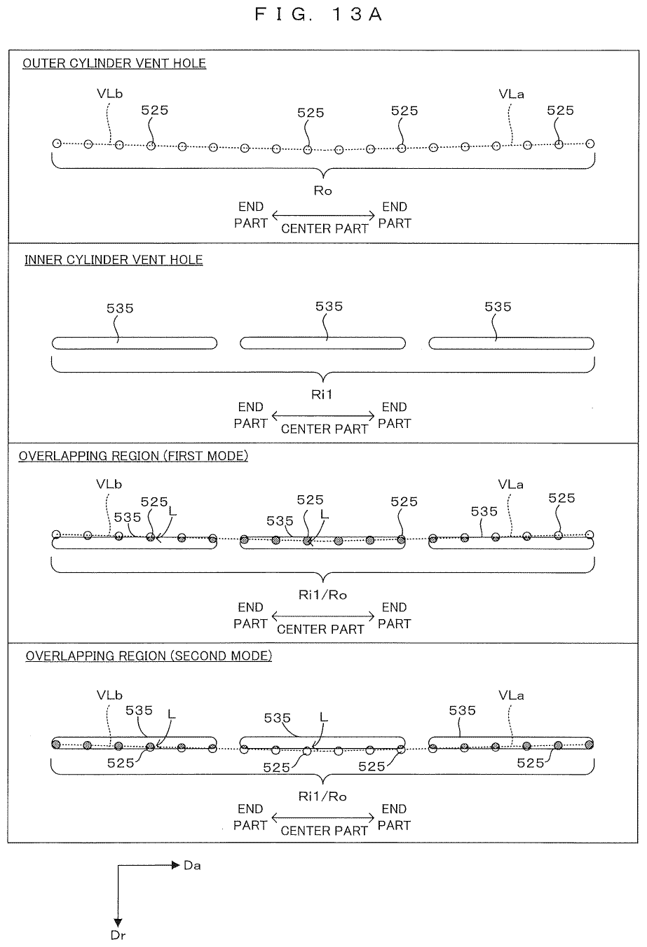

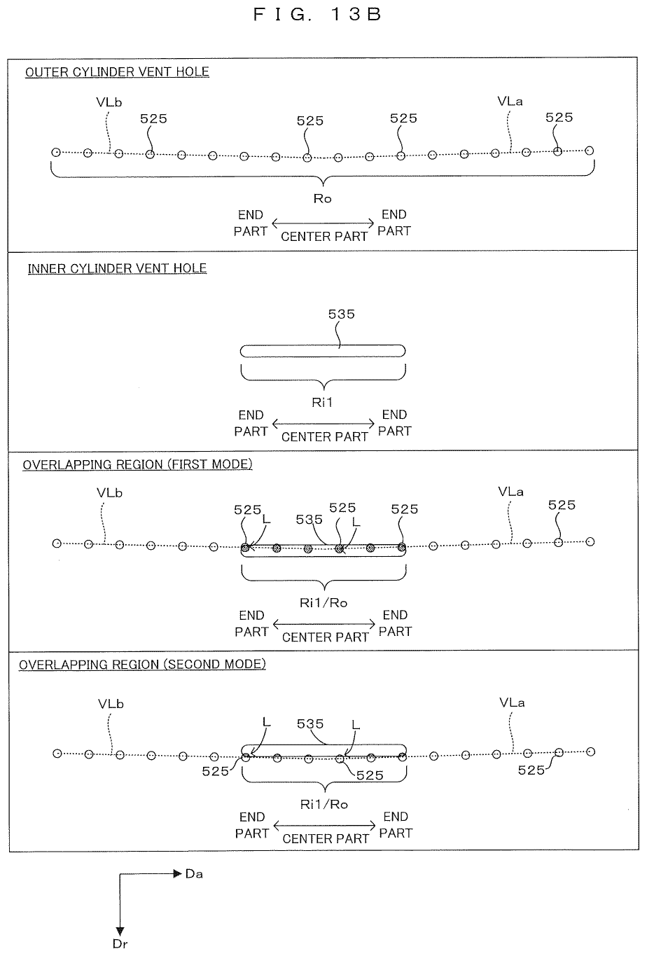

FIGS. 13A and 13B are charts schematically showing a first modification of the outer cylinder vent holes and the inner cylinder vent holes. In this example, three inner cylinder vent holes 535 are provided in parallel to the axial direction Da in the first inner cylinder vent hole formation range Ri1, and one inner cylinder vent hole 535 is provided in parallel to the axial direction Da in the third inner cylinder vent hole formation range Ri3. Further, the second inner cylinder vent hole formation range Ri2 is not set in this example.

One inner cylinder vent hole 535 is provided to correspond to six outer cylinder vent holes 525, and six overlapping regions L can be formed by overlapping one inner cylinder vent hole 535 and the six outer cylinder vent holes 525. As shown in field “Overlapping Regions (First Mode)” of FIG. 13A, the overlapping regions L can be formed in the first mode in the first inner cylinder vent hole formation range Ri1 by adjusting the rotation angle of the inner cylinder 53 in the rotation direction Dr. Further, as shown in field “Overlapping Regions (Second Mode)” of FIG. 13A, the overlapping regions L can be formed in the second mode in the first inner cylinder vent hole formation range Rif by adjusting the rotation angle of the inner cylinder 53 in the rotation direction Dr. Furthermore, as shown in field “Overlapping Regions (First Mode)” of FIG. 13B, the overlapping regions L can be formed in the first mode in the third inner cylinder vent hole formation range Ri3 by adjusting the rotation angle of the inner cylinder 53 in the rotation direction Dr. Further, as shown in field “Overlapping Regions (Second Mode)” of FIG. 13B, the overlapping regions L can be formed in the second mode in the third inner cylinder vent hole formation range Ri3 by adjusting the rotation angle of the inner cylinder 53 in the rotation direction Dr.

Note that, depending on the characteristic of the printing medium M, waving may occur in end parts of the printing medium M in the width direction besides wavy creases (troughs) oblique to a moving direction of the printing medium M in some cases. In this respect, in the ink-jet printer 3 of the above embodiment shown in FIG. 2, the concave roller 463, 475 is arranged upstream of the printing part in the conveying direction of the printing medium M and supports the printing medium M before the ink(s) is/are discharged from the printing part in a relationship with the printing part such as the color printing part 32 or white printing part 33. Further, the suction roller 471, 491 is arranged downstream of the printing part in the conveying direction of the printing medium M, and supports the printing medium M after the ink(s) is/are discharged from the printing part. By having such an arrangement relationship of the concave roller and the suction roller, the waving of the printing medium M near the color printing part 32 or white printing part 33 can be suppressed and print quality is easily ensured by suppressing the above trough creases by the concave roller 463, 475 arranged on an upstream side and strengthening the suction pressure at both ends by the suction roller 471, 491.

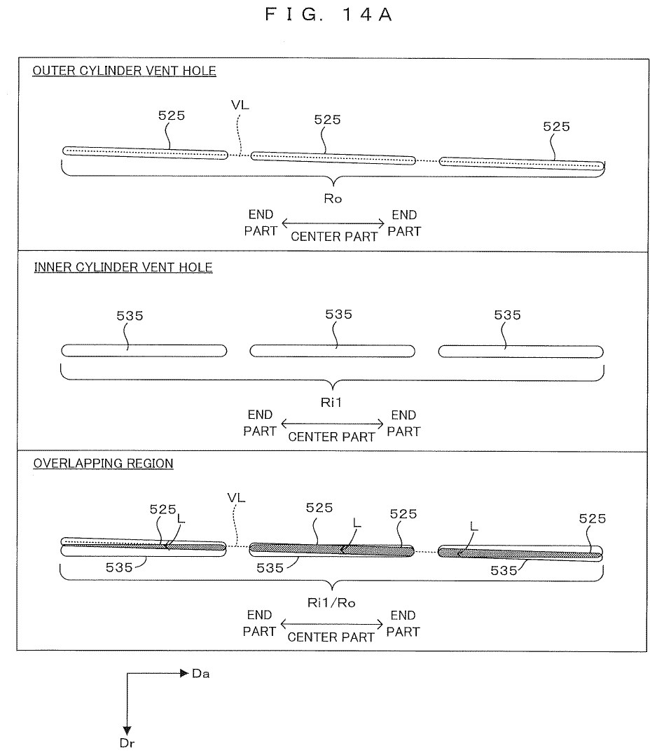

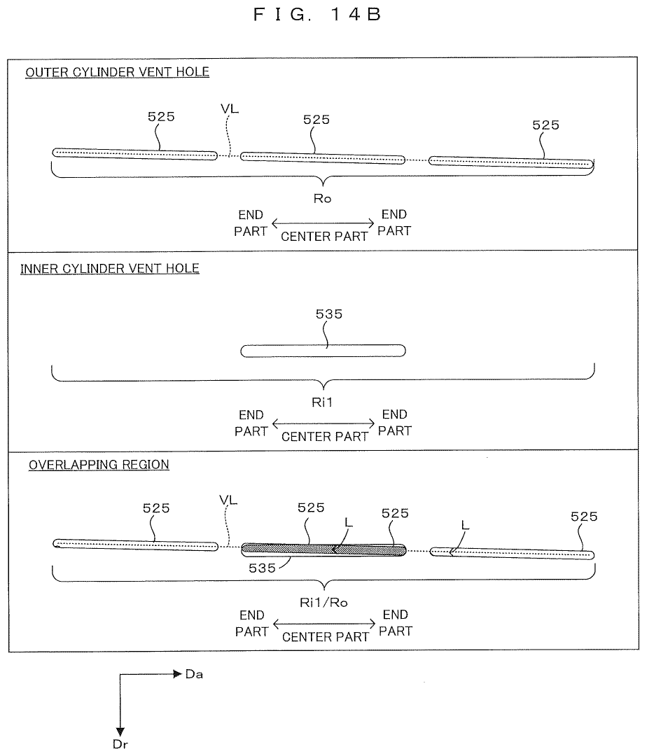

FIGS. 14A and 14B are charts schematically showing a second modification of the outer cylinder vent holes and the inner cylinder vent holes. In this example, three outer cylinder vent holes 525 are provided in the outer cylinder vent hole formation range Ro. These three outer cylinder vent holes 525 are linearly arrayed along a virtual inclined straight line VL inclined with respect to the axial direction Da. Further, three inner cylinder vent holes 535 are provided in parallel to the axial direction Da in the first inner cylinder vent hole formation range Ri1, and one inner cylinder vent hole 535 is provided in parallel to the axial direction Da in the third inner cylinder vent hole formation range Ri3. Further, the second inner cylinder vent hole formation range Ri2 is not set in this example.

One inner cylinder vent hole 535 is provided to correspond to one outer cylinder vent hole 525, and one overlapping region L can be formed by overlapping one inner cylinder vent hole 535 and one outer cylinder vent holes 525. As shown in field “Overlapping Regions” of FIG. 14A, three overlapping regions L can be formed in the first inner cylinder vent hole formation range Ri1 by adjusting the rotation angle of the inner cylinder 53 in the rotation direction Dr. As described above, since the arrangement direction of the outer cylinder vent holes 525 (extending direction of the virtual inclined straight line VL) is inclined, the length of the overlapping region L in the rotation direction Dr becomes shorter from the central part to the end parts of the first inner cylinder vent hole formation range Ri1. Further, as shown in field “Overlapping Regions” of FIG. 14B, one overlapping region L can be formed in the third inner cylinder vent hole formation range Ri3 by adjusting the rotation angle of the inner cylinder 53 in the rotation direction Dr. As described above, since the arrangement direction of the outer cylinder vent holes 525 (extending direction of the virtual inclined straight line VL) is inclined, the length of the overlapping region L in the rotation direction Dr becomes shorter from the central part to the end parts of the third inner cylinder vent hole formation range Ri3.

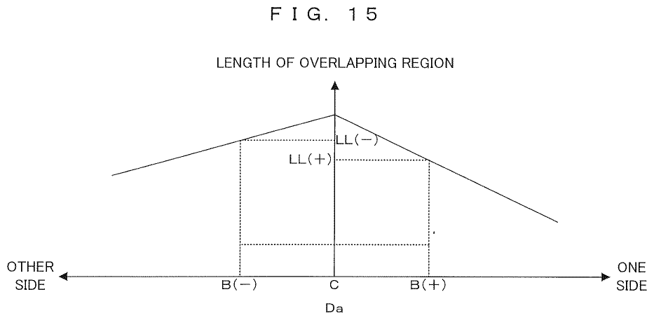

In the above example, the lengths of the overlapping regions L in the rotation direction Dr are symmetrical with respect to the center of the outer cylinder 52. However, as shown in FIG. 15, the lengths of the overlapping regions L in the rotation direction Dr may be changed in the axial direction Da. FIG. 15 is a chart showing a modification of a mode of change of the lengths in the rotation direction of the overlapping regions in the axial direction by a graph. In the graph of FIG. 15, a horizontal axis represents the position in the axial direction Da, and a vertical axis represents the length of the overlapping region L in the rotation direction Dr. Further, one side in the axial direction Da is a side near the suction port 536 of the inner cylinder 53, and the other side in the axial direction Da is a side distant from the suction port 536 of the inner cylinder 53. Further, the vertical axis of the graph of FIG. 15 represents the length of the overlapping region L in the rotation direction Dr. Also in this example, the length of the overlapping region L becomes shorter from the center part toward the end parts in the axial direction Da.

Further, in an example of FIG. 15, the outer cylinder 52 and the inner cylinder 53 are configured such that a length LL(−) of the overlapping region L at a position B(−) distant from the suction port 536 is longer than a length LL(+) of the overlapping region L at a position B(+) near the suction port 536 for two positions B(+), B(−) located on opposite sides across a center C of the outer cylinder 52 (i.e. center of the outer cylinder vent hole formation range Ro) and equidistant from the center C in the axial direction Da (longitudinal direction). That is, the more distant from the suction port 536, the weaker the pressure applied to the overlapping region L by the blower 72 (suction source). Thus, the pressure of the cylindrical roller 51 to suck the printing medium M may become asymmetrical with respect to a center in the axial direction Da. In contrast, in the above configuration, it can be suppressed that the pressure for sucking the printing medium M becomes asymmetrical.

Although the inner cylinder 53 is relatively moved in the rotation direction with respect to the outer cylinder 52 in the above embodiment, there is no limitation to this. The inner cylinder 53 may be moved in a horizontal direction with respect to the outer cylinder 52 and the outer cylinder vent holes 525 and the inner cylinder vent holes 535 may be formed accordingly.

As described above, in this embodiment, the printing medium M corresponds to an example of a “base material” of the invention, the suction roller 5 corresponds to an example of a “suction roller” of the invention, the openings 515 correspond to an example of “openings” of the invention, the outer peripheral surface 513 corresponds to an example of an “outer peripheral surface” of the invention, the axis of rotation A corresponds to an example of a “cylindrical axis” of the invention, the cylindrical roller 51 corresponds to an example of a “cylindrical roller” of the invention, the outer cylinder vent hole 525 corresponds to an example of an “outer cylinder vent hole” of the invention, the outer peripheral surface 523 corresponds to an example of an “outer peripheral surface” of the invention, the outer cylinder 52 corresponds to an example of an “outer cylinder” of the invention, the blower 72 corresponds to an example of a “suction source” of the invention, the suction port 536 corresponds to an example of a “suction port” of the invention, the inner cylinder vent hole 535 corresponds to an example of an “inner cylinder vent hole” of the invention, the outer peripheral surface 533 corresponds to an example of an “outer peripheral surface” of the invention, the inner cylinder 53 corresponds to an example of an “inner cylinder” of the invention, the axial direction Da corresponds to an example of a “longitudinal direction” of the invention, the suction chambers 54 correspond to an example of “suction chambers” of the invention, the overlapping region L corresponds to an example of an “overlapping region” of the invention, the color printing part 32 or white printing part 33 corresponds to an example of a “printing part” of the invention, the motor 63 corresponds to an example of a “driving part” of the invention, the suction path 711 corresponds to an example of a “suction path” of the invention, the connection pipe 71 corresponds to an example of a “connecting part” of the invention, the pressure gauge 73 corresponds to an example of a “measuring part” of the invention, the suction controller 81 corresponds to an example of a “controller” of the invention, the motor controller 811 corresponds to an example of a “rotation controller” of the invention, the ink-jet printer 3 corresponds to an example of an “ink-jet printer” of the invention, the conveyor 4 corresponds to an example of a “conveyor” of the invention, the UI 67 corresponds to an example of an “input part” of the invention, the blower 72 corresponds to an example of a “suction part” of the invention, each of the first, second and third suction ranges Rs1, Rs2 and Rs3 corresponds to an example of a “suction width” of the invention, the motor 63 corresponds to an example of a “switching part” of the invention, the motor controller 811 corresponds to an example of a “switching controller” of the invention, the storage 82 corresponds to an example of a “storage” of the invention, and the blower controller 814 corresponds to an example of a “suction controller” of the invention.

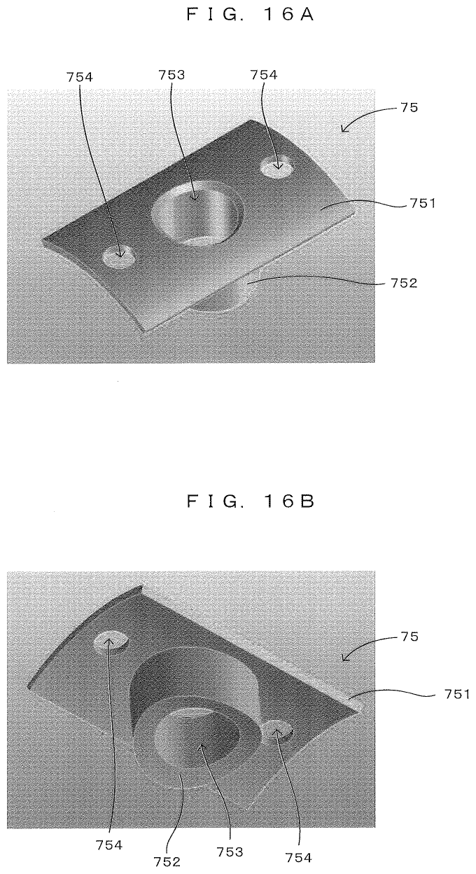

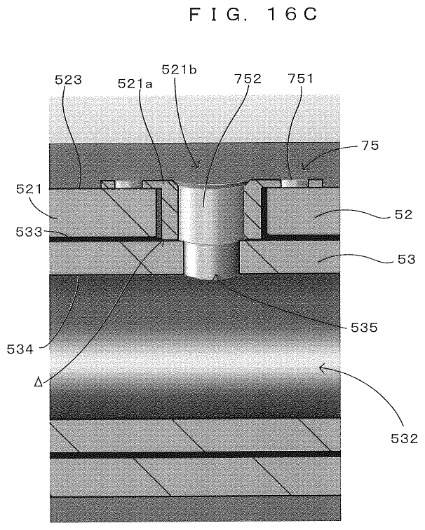

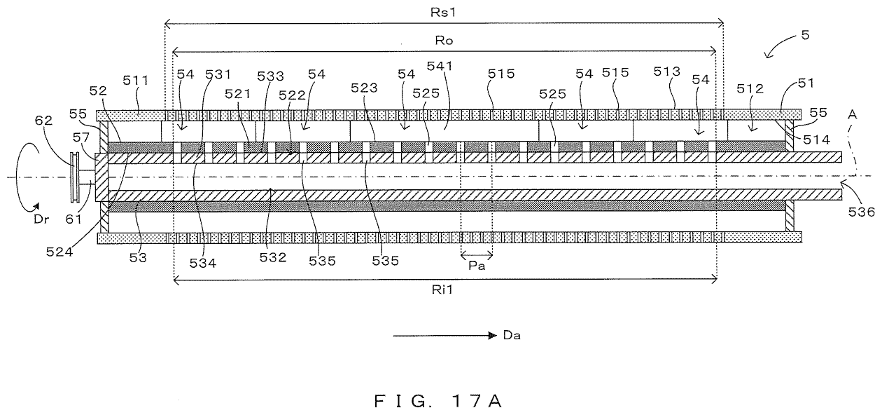

Note that the invention is not limited to the above embodiment and various changes other than the aforementioned ones can be made without departing from the gist of the invention. For example, the size of the outer cylinder vent hole 525 may be made changeable using an attachment component of FIGS. 16A to 16C. Here, FIGS. 16A and 16B are perspective views showing the attachment component of the suction roller, and FIG. 16C is a partial sectional view showing the attachment component of the suction roller.

The attachment component 75 includes a stay part 75 having an arcuate shape along the outer peripheral surface 523 of the outer cylinder 52 and a cylindrical projecting part 752 having a cylindrical shape projecting inward from a central part of the stay part 751. Further, a cylindrical hole 753 having a cylindrical shape and provided concentrically with the cylindrical projecting part 752 penetrates through the stay part 751 and the cylindrical projecting part 752. Further, the stay part 751 is provided with two screw holes 754 on both sides of the cylindrical hole 753.

On the other hand, the outer cylinder body 521 of the outer cylinder 52 includes an attachment holding part 521a for attaching the attachment component 75. A fitting hole 521b having a cylindrical shape penetrates through the attachment holding part 521a. With the cylindrical projecting part 752 of the attachment component 75 fit in the fitting hole 521b of the attachment holding part 521a, the stay part 751 of the attachment component 75 is fastened to the outer cylinder body 521 of the outer cylinder 52 by two screws inserted into the two screw holes 754. In this way, the cylindrical hole 753 of the attachment component 75 attached to the outer cylinder body 521 of the outer cylinder 52 can function as the outer cylinder vent hole 525 and communicate with the inner cylinder vent hole 535. With the attachment component 75 attached to the outer cylinder body 521 in this way, the cylindrical projecting part 752 projects toward the outer peripheral surface 533 of the inner cylinder 53 from (the attachment holding part 521a of) the outer cylinder body 521 and seals a gap A between the outer cylinder body 521 and the outer peripheral surface 533 of the inner cylinder 53.

In this example, the outer cylinder 52 includes the attachment component 75 formed with the outer cylinder vent hole 525 (cylindrical hole 753) and the outer cylinder body 521 having the outer peripheral surface 523 formed with the attachment holding part 521a (component fitting part), to which the attachment component 75 is fittable, the inner cylinder 53 being inserted into the outer cylinder body 521. Further, the attachment component 75 is detachably attached to the outer cylinder body 521 in a state fitted in the fitting hole 521b of the attachment holding part 521a. In such a configuration, by exchanging the attachment component 75 to be attached to the attachment holding part 521a of the outer cylinder body 521, the size of the outer cylinder vent hole 525 can be changed and a pressure for sucking the printing medium M can be changed as appropriate.

Further, the attachment component 75 includes the cylindrical projecting part 752 (gap sealing part) sealing the gap A by projecting into the gap A between the outer cylinder body 521 and the outer peripheral surface 533 of the inner cylinder 53 from the outer cylinder body 521. In such a configuration, air leakage into the gap A between the outer cylinder body 521 and the outer peripheral surface 533 of the inner cylinder 53 can be suppressed by the cylindrical projecting part 752 of the attachment component 75 and a desired pressure can be reliably generated in the outer cylinder vent hole 525.

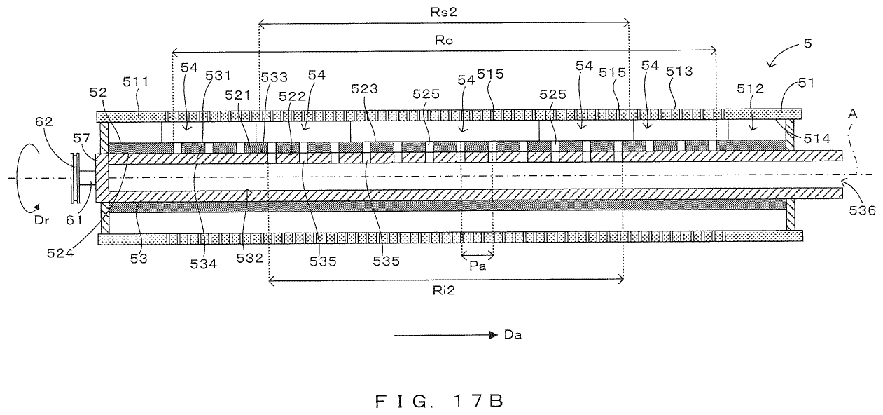

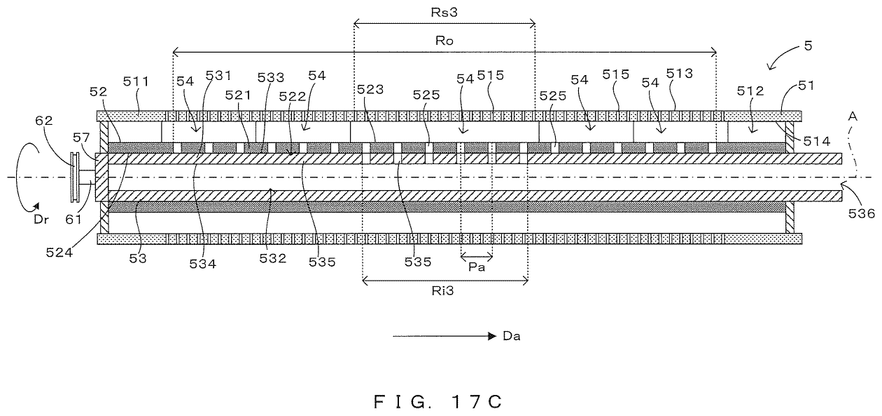

Further, the number and arrangement of the suction chambers 54 may be changed as appropriate. That is, the suction chambers 54 may be provided to be partitioned according to boundaries between the first and second suction ranges Rs1 and Rs2 and boundaries between the second and third suction ranges Rs2 and Rs3. Accordingly, the suction chambers 54 can be provided as shown in FIGS. 17A to 17C. FIGS. 17A to 17C are diagrams schematically showing a modification of a configuration relating to the suction chambers. According to this modification, one suction chamber 54 corresponding to the third suction range Rs3, two suction chambers 54 corresponding to the second suction range Rs2 without corresponding to the third suction range Rs3, and two suction chambers 54 corresponding to the first suction range Rs1 without corresponding to the second suction range Rs2 are provided.

Further, in the above example, the first, second and third suction ranges Rs1, Rs2, Rs3 are switched by fixing the outer cylinder 52 and moving the inner cylinder 53 with respect to the outer cylinder 52. However, the first, second and third suction ranges Rs1, Rs2, Rs3 may be switched by fixing the inner cylinder 53 and moving the outer cylinder 52 with respect to the inner cylinder 53.

Further, in the above example, the outer cylinder vent holes 525 are longer than the inner cylinder vent holes 535 in the rotation direction Dr. However, contrary to this, the outer cylinder vent holes 525 may be shorter than the inner cylinder vent holes 535 in the rotation direction Dr. Alternatively, the outer cylinder vent holes 525 and the inner cylinder vent holes 535 may have the same length in the rotation direction Dr.

### INDUSTRIAL APPLICABILITY

The invention is applicable to techniques in general for sucking a base material by a suction roller.

Various specific aspect of arranging the outer cylinder vent hole or the inner cylinder vent hole can be assumed. For example, the suction roller may be configured so that a plurality of the outer cylinder vent holes, air passing through each of the outer cylinder vent holes, are formed at positions different from each other in the longitudinal direction in the outer peripheral surface of the outer cylinder, the outer cylinder is configured such that each of the plurality of outer cylinder vent holes communicates with the corresponding one of the plurality of suction chambers, and the opening corresponding to the suction chamber communicating with the outer cylinder vent hole forming the overlapping region together with the inner cylinder vent hole sucks air when the suction port of the inner cylinder receives a suction force from the suction source. The suction roller may be configured so that a plurality of the inner cylinder vent holes, air passing through each of the inner cylinder vent holes, are formed at positions different from each other in the longitudinal direction in the outer peripheral surface of the inner cylinder.

The suction roller may be configured so that an arrangement direction of the outer cylinder vent hole and an arrangement direction of the inner cylinder vent hole are inclined to each other such that a length of the overlapping region becomes shorter from the center toward the both ends in the longitudinal direction. In this way, the problem of creasing the base material sucked by the suction roller can be solved by changing the pressure for sucking the base material between the central part and the both end parts of the cylindrical roller as described above by a relatively simple configuration of inclining an arrangement direction of the outer cylinder vent hole and an arrangement direction of the inner cylinder vent hole to each other.

The suction roller may be configured so that the outer cylinder and the inner cylinder are configured such that a length of the overlapping region at a position distant from the suction port is longer than a length of the overlapping region at a position near the suction port for two positions located on opposite sides across a center of the outer cylinder and equidistant from the center in the longitudinal direction. That is, the more distant from the suction port, the weaker the pressure applied to the overlapping region by the suction source. Thus, the pressure of the cylindrical roller to suck the base material may become asymmetrical with respect to a center in the longitudinal direction. In contrast, in the above configuration, it can be suppressed that the pressure for sucking the printing medium becomes asymmetrical.

The suction roller may be configured so that the inner cylinder is configured to be relatively movable in a predetermined moving direction with respect to the outer cylinder, and the outer cylinder and the inner cylinder are configured such that a length of the overlapping region in the moving direction is adjustable to become shorter from the center toward the both ends in the longitudinal direction by relatively moving the inner cylinder in the moving direction with respect to the outer cylinder to change a positional relationship between the outer cylinder vent hole and the inner cylinder vent hole. In such a configuration, the crease of the base material sucked by the suction roller can be suppressed by relatively moving the inner cylinder in the moving direction with respect to the outer cylinder to adjust such that the length of the overlapping region in the moving direction becomes shorter from the center toward the both ends in the longitudinal direction.

Various specific aspect of arranging the outer cylinder vent hole or the inner cylinder vent hole can be assumed. For example, the suction roller may be configured so that a plurality of the outer cylinder vent holes, air passing through each of the outer cylinder vent holes, are formed at positions different from each other in the longitudinal direction in the outer peripheral surface of the outer cylinder, the outer cylinder is configured such that each of the plurality of outer cylinder vent holes communicates with the corresponding one of the plurality of suction chambers, and the opening corresponding to the suction chamber communicating with the outer cylinder vent hole forming the overlapping region together with the inner cylinder vent hole sucks air when the suction port of the inner cylinder receives a suction force from the suction source. The suction roller may be configured so that a plurality of the inner cylinder vent holes, air passing through each of the inner cylinder vent holes, are formed at positions different from each other in the longitudinal direction in the outer peripheral surface of the inner cylinder.

The suction roller may be configured so that the moving direction is a rotation direction about the cylindrical axis, and an arrangement direction of the outer cylinder vent hole and an arrangement direction of the inner cylinder vent hole are inclined to each other such that a length of the overlapping region in the rotation direction changes according to position in the longitudinal direction. In such a configuration, the pressure for sucking the base material can be changed in the longitudinal direction according to the characteristic of the base material by relatively rotating the inner cylinder with respect to the outer cylinder to adjust the length of the overlapping region in the moving direction. As a result, the problem of creasing the base material sucked by the suction roller can be solved.

Various specific aspect of arranging the outer cylinder vent hole or the inner cylinder vent hole can be assumed. For example, the suction roller may be configured so that either the outer cylinder vent holes or the inner cylinder vent holes are arranged in parallel to the longitudinal direction and the others are arranged to be inclined with respect to the longitudinal direction. Further, the suction roller may be configured so that the others are linearly arranged in a direction inclined with respect to the longitudinal direction. The suction roller may be configured so that the others are arranged side by side into a V shape inclined with respect to the cylindrical axis from both ends toward a central side in the longitudinal direction.

An ink-jet printer may comprises: a conveyor including the suction roller described above, the conveyor configured to convey the base material; a printing part configured to print an image on the base material being conveyed by the conveyor by discharging an ink from an ink-jet nozzle, a driving part configured to relatively move the inner cylinder in the moving direction with respect to the outer cylinder; a connecting part including a suction path connected to the suction source to form a flow path between them and connected the suction port of the inner cylinder to form a flow path between them; a measuring part configured to measure the suction force applied to the suction port; and a controller, the controller including a rotation controller configured to control a rotation amount of the inner cylinder with respect to the outer cylinder based on a value of the suction force measured by the measuring part. In such a configuration, the base material can be sucked with an appropriate pressure suitable to suppress the crease of the base material and the crease of the base material can be suppressed by controlling a movement amount of the inner cylinder with respect to the outer cylinder based on the value of the suction force measured by the measuring part.

The ink-jet printer may further comprises a storage storing widths of a plurality of the base materials and values of suction forces for sucking the suction roller by the suction part in association with each other, wherein: the controller includes a suction controller configured to control the suction part to read out a corresponding suction force from the storage according to the width of the base material input to the input part and suck the suction roller with the read-out suction force. In such a configuration, if the data representing the width of the base material is input to the input part, the suction controller of the controller reads out the suction force corresponding to this width of the base material from the storage and controls the suction part to suck the suction roller with the read-out suction force. Therefore, the base material can be properly sucked with a suction force corresponding to the characteristic of the base material.

The ink-jet printer may be configured so that the suction roller is arranged at a position to suck and convey the base material immediately after the image is printed thereon by the printer. In such a configuration, the base material immediately after the image is printed thereon can be stably supported by the suction roller.

The ink-jet printer may be configured so that the suction roller includes: a cylindrical roller having an outer peripheral surface formed with a plurality of openings to suck and support the base material, the cylindrical roller being configured to rotate about a cylindrical axis; an outer cylinder having an outer peripheral surface formed with an outer cylinder vent hole, through which air passes, the outer cylinder being inserted into the cylindrical roller;
an inner cylinder having a suction port receiving a suction force from a suction source, the inner cylinder being inserted in the outer cylinder and configured to rotate in a rotation direction centered on the cylindrical axis; and a plurality of suction chambers formed to be arranged in a longitudinal direction between an inner peripheral surface of the cylindrical roller and the outer peripheral surface of the outer cylinder, the cylindrical roller is configured such that each of the plurality of openings communicates with the corresponding one of the plurality of suction chambers, a plurality of inner cylinder vent hole formation ranges provided at positions different from each other in the rotation direction and having widths different from each other in the longitudinal direction are provided on an outer peripheral surface of the inner cylinder, an inner cylinder vent hole, through which air passes, is provided in each of the plurality of inner cylinder vent hole formation ranges, an overlapping region is formed by overlapping the outer cylinder vent hole and the inner cylinder vent hole in the inner cylinder vent hole formation range facing the outer cylinder vent hole, the outer cylinder and the inner cylinder are configured such that air is sucked toward the suction port via the overlapping region from the suction chamber facing the overlapping region of the inner cylinder vent hole and the outer cylinder vent hole, out of the plurality of suction chambers, when the suction port of the inner cylinder receives a suction force from the suction source, the switching part switches the suction width by rotating the inner cylinder to switch the inner cylinder vent hole formation range facing the outer cylinder vent hole, among the plurality of inner cylinder vent hole formation ranges, and a length of one of the outer cylinder vent hole and the inner cylinder vent hole is longer than that of the other in the rotation direction.

The ink-jet printer thus configured is provided with the cylindrical roller, the outer cylinder inserted in the cylindrical roller and the plurality of suction chambers formed to be arranged in the longitudinal direction between the inner peripheral surface of the cylindrical roller and the outer peripheral surface of the outer cylinder. The plurality of openings for sucking and supporting the base material are formed in the outer peripheral surface of the cylindrical roller, and the cylindrical roller is configured such that each of the plurality of openings communicates with the corresponding one of the plurality of suction chambers. Further, the outer cylinder vent hole, through which air can pass, is formed in the outer peripheral surface of the outer cylinder. Furthermore, the inner cylinder is provided which has the outer peripheral surface formed with the inner cylinder vent hole, through which air can pass, and is inserted in the outer cylinder. The overlapping region is formed by overlapping the outer cylinder vent hole and the inner cylinder vent hole in the inner cylinder vent hole formation range facing the outer cylinder vent hole. If the suction port of the inner cylinder receives a suction force from the suction source, air is sucked toward the suction port from the suction chamber facing the overlapping region of the inner cylinder vent hole and the outer cylinder vent hole, out of the plurality of suction chambers, via the overlapping region. Thus, the suction width of the cylindrical roller to suck the base material can be changed by changing the inner cylinder vent hole formation range at a position facing the outer cylinder vent hole, out of the plurality of inner cylinder vent hole formation ranges, to change a width, over which the overlapping region is formed. That is, the switching part can switch the suction width by rotating the inner cylinder to switch the inner cylinder vent hole formation range facing the outer cylinder vent hole, out of the plurality of inner cylinder vent hole formation ranges. Moreover, one of the outer cylinder vent hole and the inner cylinder vent hole is longer than the other in the rotating direction. Thus, even if the position of the inner cylinder vent hole caused to face the outer cylinder vent hole is slightly shifted in the rotating direction, the overlapping region of a desired length can be formed. As a result, positioning accuracy required for the switching controller for controlling the switching part for rotating the inner cylinder in the rotating direction is not high, and the suction width can be switched by a simple control.

The suction roller may be configured so that the outer cylinder includes: an attachment component formed with the outer cylinder vent hole; and an outer cylinder body having an outer peripheral surface formed with a component fitting part, the attachment component being configured to be fitted to the component fitting part, the inner cylinder being inserted into the outer cylinder body, and the attachment component is detachably attached to the outer cylinder body in a state fitted to the component fitting part. In such a configuration, the size of the outer cylinder vent hole can be changed and a pressure for sucking the base material can be changed as appropriate by exchanging the attachment component to be attached to the component fitting part of the outer cylinder body.

The suction roller may be configured so that the attachment component includes a gap sealing part sealing a gap between the outer cylinder body and an outer peripheral surface of the inner cylinder by projecting into the gap from the outer cylinder body. In such a configuration, air leakage into the gap between the outer cylinder body and the outer peripheral surface of the inner cylinder can be suppressed by the gap sealing part of the attachment component, and a desired pressure can be reliably generated at the outer cylinder vent hole.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. A suction roller conveying a base material while sucking and supporting the base material, comprising:
a cylindrical roller having an outer peripheral surface formed with a plurality of openings to suck and support the base material, the cylindrical roller configured to rotate about a cylindrical axis,
an outer cylinder having an outer peripheral surface formed with an outer cylinder vent hole through which air passes, the outer cylinder being inserted into the cylindrical roller;
an inner cylinder having a suction port receiving a suction force from a suction source and an outer peripheral surface formed with an inner cylinder vent hole through which air passes, the inner cylinder being inserted in the outer cylinder; and
a plurality of suction chambers formed to be arranged in a longitudinal direction between an inner peripheral surface of the cylindrical roller and the outer peripheral surface of the outer cylinder,
the cylindrical roller being configured such that each of the plurality of openings communicates with the corresponding one of the plurality of suction chambers,
an overlapping region being formed by overlapping the outer cylinder vent hole and the inner cylinder vent hole,
the outer cylinder and the inner cylinder being configured such that air is sucked toward the suction port via the overlapping region from the suction chamber facing the overlapping region of the inner cylinder vent hole and the outer cylinder vent hole, out of the plurality of suction chambers, when the suction port of the inner cylinder receives a suction force from the suction source, and
the outer cylinder and the inner cylinder being configured such that the overlapping region becomes narrower from a center toward both ends in the longitudinal direction.

2. The suction roller according to claim 1, wherein:
a plurality of the outer cylinder vent holes, air passing through each of the outer cylinder vent holes, are formed at positions different from each other in the longitudinal direction in the outer peripheral surface of the outer cylinder,
the outer cylinder is configured such that each of the plurality of outer cylinder vent holes communicates with the corresponding one of the plurality of suction chambers, and
the opening corresponding to the suction chamber communicating with the outer cylinder vent hole forming the overlapping region together with the inner cylinder vent hole sucks air when the suction port of the inner cylinder receives a suction force from the suction source.

3. The suction roller according to claim 2, wherein:
a plurality of the inner cylinder vent holes, air passing through each of the inner cylinder vent holes, are formed at positions different from each other in the longitudinal direction in the outer peripheral surface of the inner cylinder.

4. The suction roller according to claim 1, wherein an arrangement direction of the outer cylinder vent hole and an arrangement direction of the inner cylinder vent hole are inclined to each other such that a length of the overlapping region becomes shorter from the center toward the both ends in the longitudinal direction.

5. The suction roller according to claim 1, wherein the outer cylinder and the inner cylinder are configured such that a length of the overlapping region at a position distant from the suction port is longer than a length of the overlapping region at a position near the suction port for two positions located on opposite sides across a center of the outer cylinder and equidistant from the center in the longitudinal direction.

6. The suction roller according to claim 1, wherein:
the inner cylinder is configured to be relatively movable in a predetermined moving direction with respect to the outer cylinder, and
the outer cylinder and the inner cylinder are configured such that a length of the overlapping region in the moving direction is adjustable to become shorter from the center toward the both ends in the longitudinal direction by relatively moving the inner cylinder in the moving direction with respect to the outer cylinder to change a positional relationship between the outer cylinder vent hole and the inner cylinder vent hole.

7. The suction roller according to claim 1, wherein:
the outer cylinder includes:
an attachment component formed with the outer cylinder vent hole; and
an outer cylinder body having an outer peripheral surface formed with a component fitting part, the attachment component being configured to be fitted to the component fitting part, the inner cylinder being inserted into the outer cylinder body, and
the attachment component is detachably attached to the outer cylinder body in a state fitted to the component fitting part.

8. The suction roller according to claim 7, wherein:
the attachment component includes a gap sealing part sealing a gap between the outer cylinder body and an outer peripheral surface of the inner cylinder by projecting into the gap from the outer cylinder body.

9. A suction roller conveying a base material while sucking and supporting the base material, comprising:
a cylindrical roller having an outer peripheral surface formed with a plurality of openings to suck and support the base material, the cylindrical roller configured to rotate about a cylindrical axis,
an outer cylinder having an outer peripheral surface formed with an outer cylinder vent hole, through which air passes, the outer cylinder being inserted into the cylindrical roller;
an inner cylinder having a suction port receiving a suction force from a suction source and an outer peripheral surface formed with an inner cylinder vent hole, through which air passes, the inner cylinder being inserted into the outer cylinder and configured to be relatively movable in a predetermined moving direction with respect to the outer cylinder; and
a plurality of suction chambers formed to be arranged in a longitudinal direction between an inner peripheral surface of the cylindrical roller and the outer peripheral surface of the outer cylinder,
the cylindrical roller being configured such that each of the plurality of openings communicates with the corresponding one of the plurality of suction chambers,
an overlapping region being formed by overlapping the outer cylinder vent hole and the inner cylinder vent hole,
the outer cylinder and the inner cylinder being configured such that air is sucked toward the suction port via the overlapping region from the suction chamber facing the overlapping region of the inner cylinder vent hole and the outer cylinder vent hole, out of the plurality of suction chambers, when the suction port of the inner cylinder receives a suction force from the suction source,
a length of the overlapping region in the moving direction changing according to position in the longitudinal direction, and
the outer cylinder and the inner cylinder being configured such that the length of the overlapping region in the moving direction being adjustable by relatively moving the inner cylinder in the moving direction with respect to the outer cylinder to change a positional relationship between the outer cylinder vent hole and the inner cylinder vent hole.

10. The suction roller according to claim 9, wherein:
a plurality of the outer cylinder vent holes, air passing through each of the outer cylinder vent holes, are formed at positions different from each other in the longitudinal direction in the outer peripheral surface of the outer cylinder,
the outer cylinder is configured such that each of the plurality of outer cylinder vent holes communicates with the corresponding one of the plurality of suction chambers, and
the opening corresponding to the suction chamber communicating with the outer cylinder vent hole forming the overlapping region together with the inner cylinder vent hole sucks air when the suction port of the inner cylinder receives a suction force from the suction source.

11. The suction roller according to claim 10, wherein:
a plurality of the inner cylinder vent holes, air passing through each of the inner cylinder vent holes, are formed at positions different from each other in the longitudinal direction in the outer peripheral surface of the inner cylinder.

12. The suction roller according to claim 9, wherein:
the moving direction is a rotation direction about the cylindrical axis, and
an arrangement direction of the outer cylinder vent hole and an arrangement direction of the inner cylinder vent hole are inclined to each other such that a length of the overlapping region in the rotation direction changes according to position in the longitudinal direction.

13. The suction roller according to claim 11, wherein:
either the outer cylinder vent holes or the inner cylinder vent holes are arranged in parallel to the longitudinal direction and the others are arranged to be inclined with respect to the longitudinal direction.

14. The suction roller according to claim 13, wherein:
the others are linearly arranged in a direction inclined with respect to the longitudinal direction.

15. The suction roller according to claim 13, wherein:
the others are arranged side by side into a V shape inclined with respect to the cylindrical axis from both ends toward a central side in the longitudinal direction.

16. The suction roller according to claim 9, wherein:
the outer cylinder includes:
an attachment component formed with the outer cylinder vent hole; and
an outer cylinder body having an outer peripheral surface formed with a component fitting part, the attachment component being configured to be fitted to the component fitting part, the inner cylinder being inserted into the outer cylinder body, and
the attachment component is detachably attached to the outer cylinder body in a state fitted to the component fitting part.

17. The suction roller according to claim 16, wherein:
the attachment component includes a gap sealing part sealing a gap between an inner peripheral surface of the outer cylinder body and an outer peripheral surface of the inner cylinder by projecting into the gap from the inner peripheral surface of the outer cylinder body.

18. An ink-jet printer, comprising:
a conveyor including the suction roller according to claim 9, the conveyor configured to convey the base material;
a printing part configured to print an image on the base material being conveyed by the conveyor by discharging an ink from an ink-jet nozzle,
a driving part configured to relatively move the inner cylinder in the moving direction with respect to the outer cylinder;
a connecting part including a suction path connected to the suction source to form a flow path between them and connected the suction port of the inner cylinder to form a flow path between them;
a measuring part configured to measure the suction force applied to the suction port; and
a controller,
the controller including a rotation controller configured to control a rotation amount of the inner cylinder with respect to the outer cylinder based on a value of the suction force measured by the measuring part.

19. An ink-jet printer printing an image on a base material by supplying an ink while conveying the base material, comprising:
a conveyor including a suction roller to suck and support the base material, the conveyor conveying the base material;
a printing part configured to print an image on the base material being conveyed by the conveyor by discharging an ink from an ink-jet nozzle;
an input part to which data representing a width of the base material is input;
a suction part configured to suck the suction roller;
a switching part configured to switch a suction width of the base material by the suction roller; and
a controller,
the controller including a switching controller configured to control the switching part to switch the suction width of the suction roller according to the width of the base material input to the input part.

20. The ink-jet printer according to claim 19, further comprising a storage storing widths of a plurality of the base materials and values of suction forces for sucking the suction roller by the suction part in association with each other, wherein:
the controller includes a suction controller configured to control the suction part to read out a corresponding suction force from the storage according to the width of the base material input to the input part and suck the suction roller with the read-out suction force.

21. The ink-jet printer according to claim 19, wherein:
the suction roller is arranged at a position to suck and convey the base material immediately after the image is printed thereon by the printer.

22. The ink-jet printer according to claim 19, wherein:
the suction roller includes:
a cylindrical roller having an outer peripheral surface formed with a plurality of openings to suck and support the base material, the cylindrical roller being configured to rotate about a cylindrical axis;
an outer cylinder having an outer peripheral surface formed with an outer cylinder vent hole, through which air passes, the outer cylinder being inserted into the cylindrical roller;
an inner cylinder having a suction port receiving a suction force from a suction source, the inner cylinder being inserted in the outer cylinder and configured to rotate in a rotation direction centered on the cylindrical axis; and
a plurality of suction chambers formed to be arranged in a longitudinal direction between an inner peripheral surface of the cylindrical roller and the outer peripheral surface of the outer cylinder,
the cylindrical roller is configured such that each of the plurality of openings communicates with the corresponding one of the plurality of suction chambers,
a plurality of inner cylinder vent hole formation ranges provided at positions different from each other in the rotation direction and having widths different from each other in the longitudinal direction are provided on an outer peripheral surface of the inner cylinder,
an inner cylinder vent hole, through which air passes, is provided in each of the plurality of inner cylinder vent hole formation ranges,
an overlapping region is formed by overlapping the outer cylinder vent hole and the inner cylinder vent hole in the inner cylinder vent hole formation range facing the outer cylinder vent hole,
the outer cylinder and the inner cylinder are configured such that air is sucked toward the suction port via the overlapping region from the suction chamber facing the overlapping region of the inner cylinder vent hole and the outer cylinder vent hole, out of the plurality of suction chambers, when the suction port of the inner cylinder receives a suction force from the suction source,
the switching part switches the suction width by rotating the inner cylinder to switch the inner cylinder vent hole formation range facing the outer cylinder vent hole, among the plurality of inner cylinder vent hole formation ranges, and
a length of one of the outer cylinder vent hole and the inner cylinder vent hole is longer than that of the other in the rotation direction.

23. The ink-jet printer according to claim 22, wherein:
the outer cylinder includes:
an attachment component formed with the outer cylinder vent hole; and
an outer cylinder body having an outer peripheral surface formed with a component fitting part, the attachment component being configured to be fitted to the component fitting part, the inner cylinder being inserted into the outer cylinder body, and
the attachment component is detachably attached to the outer cylinder body in a state fitted to the component fitting part.

24. The ink-jet printer according to claim 23, wherein:
the attachment component includes a gap sealing part sealing a gap between an inner peripheral surface of the outer cylinder body and an outer peripheral surface of the inner cylinder by projecting into the gap from the inner peripheral surface of the outer cylinder body.

25. A suction width adjustment method by a suction roller in an ink-jet printer printing an image on a base material by supplying an ink while conveying the base material by a conveyor including the suction roller to suck and support the base material, comprising:
inputting data representing a width of the base material to an input part; and
controlling a switching part switching the suction width such that the suction width of the suction roller to suck the base material is switched according to the width of the base material input to the input part.
